(19) United States
(12) Patent Application Publication
(10) Pub. No.: US 2026/0300759 A1
(43) Pub. Date: Oct. 1, 2026

(54) SYSTEM AND METHODS OF TRAINING AND OPERATION FOR A GENERAL ARTIFICIAL INTELLIGENCE SYSTEM FOR DATA GENERATION IN BEHAVIORAL CONTROL SYSTEMS

(71) Applicant: Joseph Juma, San Rafael, CA (US)

(72) Inventor: Joseph Juma, San Rafael, CA (US)

(21) Appl. No.: 19/691,375

(22) Filed: May 28, 2026

Related U.S. Application Data
(63) Continuation-in-part of application No. 19/289,558, filed on Aug. 4, 2025.
(60) Provisional application No. 63/680,062, filed on Aug. 6, 2024.

(51) Int. Cl. G06N 5/01; G06F 8/30; G06F 9/448

(52) U.S. Cl. CPC G06N 5/01; G06F 8/30; G06F 9/4498

(57) ABSTRACT

An agentic artificial intelligence control system and an associated method of training, operating, and transforming an agentic artificial intelligence control system are disclosed. Disclosed control systems may comprise an agentic AI core, a training engine, a transformation engine, an execution runtime, a representation store, an interface layer, and a higher-order orchestrator. The method of training, operating, and transforming an agentic artificial intelligence control system enables collection of state-decision training data, training of agentic models using weighted-set updates, and orchestration of multiple decision policies. The transformation engine systematically converts trained agentic models into alternative representations, including behavior trees, decision trees, finite state machines, and hard-coded logic, by collapsing weighted-set into deterministic or stochastic logic nodes. The invention enables deployment of learned control logic into legacy or resource-constrained systems, supports interpretable and reusable agentic AI across diverse domains, and provides a unified framework for transforming learned behavior into multiple logical representations.

### CROSS REFERENCE TO RELATED APPLICATIONS

The utility application is a Continuation in Part (CIP) of patent application Ser. No. 19/289,558 filed on Aug. 4, 2025 which claims the benefit of and priority of application 63/680,062 filed on Aug. 6, 2024, the contents of which are incorporated herein as if restated herein.

### TECHNICAL FIELD

This invention relates generally to the field of artificial intelligence based behavioral control systems and more specifically to a new and useful system and methods of training and operation for a general artificial intelligence system for data generation in behavioral control systems in the field of artificial intelligence based behavioral control systems.

### BACKGROUND

Artificial intelligence based behavioral control systems have become increasingly prevalent in a wide range of domains, including operating systems, software applications, video games, and electromechanical devices. Traditional approaches to behavioral control in these domains have relied heavily on finite state machines (FSMs), behavior trees, decision trees, or hard-coded conditional logic. However, deploying learned AI-based behavioral control logic into legacy or resource-constrained systems that utilize such structures has proven to be challenging. Existing methods often require significant manual intervention to translate complex, learned behaviors into the rigid frameworks supported by these systems, resulting in inefficiencies and limited scalability.

Prior art in the field has also lacked a unified agentic AI structure that can be trained from state-decision data and subsequently reused across diverse application domains. Conventional solutions tend to be domain-specific, necessitating the development of bespoke behavioral models for each new environment. This fragmentation impedes the transferability and reusability of learned behavioral logic, increasing development time and maintenance overhead.

Another significant limitation of conventional AI models is the inability to systematically transform learned models into interpretable logical trees, finite state machines, or source-code level conditional logic while preserving the fidelity of the learned behavior. Existing AI models, such as neural networks or probabilistic models, often function as opaque black boxes, making it difficult to extract interpretable and verifiable control logic suitable for deployment in systems that require transparency and predictability.

Behavior trees and finite state machines in the prior art are typically hand-authored, resulting in rigid structures that are expensive to design and maintain. These manually constructed controllers are not easily adaptable based on observed state-action data from human operators or agents, limiting their ability to evolve in response to new data or changing requirements. The lack of adaptability further increases the cost and complexity of maintaining such systems over time.

Representing complex, high-dimensional state information, such as data from sensors, application state, or user context, poses additional challenges for both efficient training and deterministic execution of control policies. Existing approaches often struggle to encode such information in a manner that supports both the learning of effective behaviors and the reliable, real-time execution required in many application domains.

Furthermore, prior art has provided insufficient mechanisms for collapsing probabilistic or weighted decision structures into deterministic or stochastic logical nodes suitable for decision trees and finite state machines. Operations such as max, min, or weighted-collapse are not systematically supported, making it difficult to translate learned probabilistic behaviors into the deterministic or semi-deterministic structures required by many control systems.

The creation of higher-order behavioral controllers capable of orchestrating multiple decision policies in a finite state automaton (FSA)-like structure for complex, context-dependent behavior has also been problematic. Existing solutions lack the flexibility and modularity needed to coordinate multiple decision-making agents within a unified control framework, limiting the expressiveness and scalability of behavioral control systems.

Finally, there is a lack of standardized methods for transforming a single learned agentic model into multiple target representations, such as behavior trees, decision trees, finite state machines, or hard-coded logic. Current practices often require redesigning behavioral logic by hand for each target environment, resulting in duplicated effort and increased potential for errors. This absence of standardized transformation methods hinders the efficient deployment of learned behaviors across heterogeneous platforms and execution environments.

### SUMMARY

The agentic artificial intelligence control system and the associated method of training, operating, and transforming an agentic artificial intelligence control system provide a comprehensive framework for developing, training, and deploying agentic AI controllers across a wide range of target environments. The agentic artificial intelligence control system comprises an agentic AI core, a training engine, a transformation engine, an execution runtime, a representation store, an interface layer, and a higher-order orchestrator. The method of training, operating, and transforming an agentic artificial intelligence control system enables the collection of state-decision training data, the initialization and training of agentic data model using weighted-set updates, the orchestration of multiple decision AIs, and the systematic transformation of trained agentic models into alternative representations such as behavior trees, decision trees, finite state machines, and hard-coded logic. The invention further provides mechanisms for merging, collapsing, and serializing control logic representations, thereby supporting deployment in both modern and legacy systems.

The agentic artificial intelligence control system addresses the difficulty of deploying learned AI-based behavioral control logic into legacy or resource-constrained systems by providing a transformation engine that includes modules for converting trained agentic models into finite state machines, behavior trees, decision trees, and hard-coded logic. The transformation engine, comprising the BT transformation module, DT transformation module, FSM transformation module, and hard-coded logic serializer, enables the generation of target representations that are compatible with legacy execution environments. This approach improves upon prior art by eliminating the need for manual redesign of control logic for each target system and by supporting efficient deployment in environments with limited computational resources.

The invention solves the lack of a unified agentic AI structure by introducing the agentic AI core, which integrates an AI associative container, AI cache, data model, weighted-set, selection functions library, and collapse functions library. The agentic AI core supports training from state-decision data and enables reuse of the trained agentic model across diverse domains, including operating systems, software applications, video games, and electromechanical devices. This unified structure contrasts with prior art, which typically requires domain-specific or bespoke AI architectures, thereby reducing development and maintenance overhead.

The agentic artificial intelligence control system and the associated method overcome the inability of conventional AI models to be systematically transformed into interpretable logical trees, finite state machines, or source-code level conditional logic by providing a transformation engine with specialized modules and function libraries. The transformation engine utilizes decision tree transformation variants, FSM transformation variants, and state delta-frequency FSM transformation variants to convert learned weighted-set structures into deterministic or stochastic logical structures, ensuring that the transformed representations preserve the learned behavior. This systematic transformation capability enables interpretable and verifiable control logic, which is not achievable with conventional black-box AI models.

The invention addresses the rigidity and high maintenance cost of hand-authored behavior trees and finite state machines by enabling the training engine to learn control policies directly from observed state-action data. The training engine, comprising the training sample processor, weight update module, and function evaluation unit, processes state-decision training datasets to produce trained decision AI model. The transformation engine then converts these models into target representations, reducing the need for manual authoring and facilitating rapid adaptation to new data or requirements.

The agentic artificial intelligence control system solves challenges in representing complex, high-dimensional state information by incorporating a state preprocessor and sensor input interface within the interface layer. The state preprocessor transforms raw state snapshot into structured data suitable for efficient training and deterministic execution. This approach enables the agentic AI core to handle high-dimensional inputs while maintaining real-time performance, an improvement over prior art systems that struggle with scalability and execution speed.

The invention provides mechanisms to collapse probabilistic or weighted decision structures into deterministic or stochastic logical nodes through the use of the collapse functions library, collapse node function library, and FSM collapse function library. These components support max, min, and weighted-collapse operations, enabling the transformation of learned weighted-set structures into logic suitable for decision trees and finite state machines. This capability ensures that the resulting control logic is both interpretable and executable in deterministic or stochastic environments, addressing a gap in existing AI-to-logic transformation methods.

The agentic artificial intelligence control system enables the creation of higher-order behavioral controllers by incorporating a higher-order orchestrator that manages a decision AI collection and a state transition manager. The higher-order orchestrator coordinates multiple decision policies in an FSA-like structure, supporting complex, context-dependent behavior. This modular orchestration capability allows for scalable and flexible behavioral control, surpassing the limitations of monolithic or single-policy controllers in the prior art.

Finally, the invention addresses the lack of standardized methods for transforming a single learned agentic model into multiple target representations by providing a method of training, operating, and transforming an agentic artificial intelligence control system that includes steps for creating mapping list, constructing base structures, populating selector nodes, collapsing weighted-set, merging generated structures, and serializing representations. The transformation engine and associated modules automate the conversion process, enabling deployment in behavior tree, decision tree, FSM, or hard-coded logic formats without manual redesign. This standardization streamlines the deployment pipeline and ensures consistency across diverse target environments.

### BRIEF DESCRIPTION OF THE DRAWINGS

FIG. 1 is a software architecture diagram of the structure of a Data Model object as it pertains to the invention.

FIG. 2 is a software architecture diagram of the structure of an AI object as it pertains to the invention.

FIG. 3 is a software architecture diagram of the structure of a Training Sample object as it pertains to the invention.

FIG. 4A is a flowchart of the general process of training the AI model.

FIG. 4B is a flowchart of the specific operations of the AI object when being provided a training sample.

FIG. 5A is a flowchart of the general process of employing the AI model for data generation.

FIG. 5B is a flowchart of the specific operations of the AI object, for the purpose of generating data.

FIG. 6 is a software architecture diagram of the structure of an AI Cache, an optional acceleration structure in the AI.

FIG. 7A is a flowchart of one embodiment of the Selection Function, referred to herein as Fuzzy Match.

FIG. 7B is a flowchart of one embodiment of the Selection Function, referred to herein as Distance Threshold.

FIG. 7C is a flowchart of one embodiment of the Selection Function, referred to herein as Distance Ordering.

FIG. 7D is a flowchart, continuing the description of the Distance Ordering (740) Selection function, referenced by FIG. 7C.

FIG. 7E is a flowchart, continuing the description of the Distance Ordering (740) Selection function, referenced by FIG. 7D.

FIG. 7F is a flowchart of one embodiment of the Selection Function, referred to herein as Distance Gradient.

FIG. 7G is a flowchart, continuing the description of the Distance Gradient (760) Selection function, referenced by FIG. 7F.

FIG. 7H is a flowchart, continuing the description of the Distance Gradient (760) Selection function, referenced by FIG. 7F.

FIG. 8A is a flowchart of one embodiment of the Collapse Function, referred to herein as Random Collapse.

FIG. 8B is a flowchart of one embodiment of the Collapse Function, referred to herein as Max Collapse.

FIG. 9A is an alteration of the Data Model object (100), for use in an embodiment of the invention in the application of image synthesis, referred to herein as an Image AI.

FIG. 9B is an alteration of the Training Model object (300), for use in an embodiment of the invention in the application of image synthesis, referred to herein as an Image AI.

FIG. 9C is a flowchart for the general steps for training the Image AI embodiment.

FIG. 9D is a flowchart of one embodiment of employing the Image AI embodiment.

FIG. 9E is an image with a sample being extracted for training.

FIG. 9F is an example of a damaged image.

FIG. 9G is the damaged image (970) after having been fixed by application of the Image AI.

FIG. 9H is an example of an arbitrary image.

FIG. 9I is an example of an image (980) after an application of the Image AI.

FIG. 10A is an alteration of the Data Model object (100), for use in an embodiment of the invention in the application of voxel spaces, referred to herein as a Voxel AI.

FIG. 10B is an alteration of the Training Model object (300), for use in an embodiment of the invention in the application of voxel spaces, referred to herein as a Voxel AI.

FIG. 10C is an example of a voxel space, and a sample being extracted from the voxel space for training.

FIG. 10D is a flowchart for the general steps for training the Voxel AI embodiment.

FIG. 10E is a flowchart of one embodiment of employing the system for operating on a voxel space.

FIG. 10F is an example of an arbitrary voxel space.

FIG. 10G is an example of a voxel space (1070) after an application of the Voxel AI.

FIG. 10H is an example of an arbitrary voxel space with missing regions.

FIG. 10I is an example of a voxel space (1080) after an application of the Voxel AI.

FIG. 11A is an alteration of the Data Model object (100), for use in an embodiment of the invention in the application of armature generation, referred to herein as an Armature AI.

FIG. 11B is an alteration of the Training Model object (300), for use in an embodiment of the invention in the application of armature generation, referred to herein as an Armature AI.

FIG. 11C is an example of an arbitrary armature rig.

FIG. 11D is a flowchart for the general steps for training the Armature AI embodiment.

FIG. 11E is an additional flowchart for the general steps for training the Armature AI embodiment, referenced by FIG. 11D.

FIG. 11F is a flowchart of one embodiment of employing an Armature AI system for generating parts of an armature.

FIG. 11G is an additional flowchart for the general steps for employing the Armature AI embodiment, referenced by FIG. 11F.

FIG. 11H is an example of a simple armature rig, comprising only a single bone.

FIG. 11I is an example of an armature rig generated from a simpler armature rig (1190).

FIG. 11J is an example of a simple armature rig, comprising of a single bone, with non-uniform scale.

FIG. 11K is an example of an armature rig generated from a non-uniform armature rig (1194).

FIG. 12A is an alteration of the Data Model object (100), for use in an embodiment of the invention in the application of node graph generation, referred to herein as a Graph AI.

FIG. 12B is an alteration of the Training Model object, for use in an embodiment of the invention in the application of nodegraph generation, referred to herein as a Graph AI.

FIG. 12C is a flowchart for the general steps for training the Music Graph AI embodiment.

FIG. 12D is a flowchart of one embodiment of employing a Graph AI system for generating parts of a musical notation graph.

FIG. 13A is an alteration of the Data Model object (100), for use in an embodiment of the invention in the application of dynamic decision systems, referred to herein as a Decision AI.

FIG. 13B is an alteration of the Training Sample object (300), for use in an embodiment of the invention in the application of dynamic decision systems, referred to herein as a Decision AI.

FIG. 13C is a flowchart for the general steps for training the Decision AI embodiment.

FIG. 13D is a flowchart of one embodiment of employing the system for generating dynamic logic from a Decision AI.

FIG. 13E is an alteration of the Data Model Object (100), for use in an embodiment of the invention in the application of multiple Decision AI systems, referred to herein as a Behavior AI.

FIG. 13F is a flowchart of one embodiment of employing a Behavior AI system for generating dynamic logic from one or more Decision AI.

FIGS. 14A and 14B are flow charts of Classifier systems

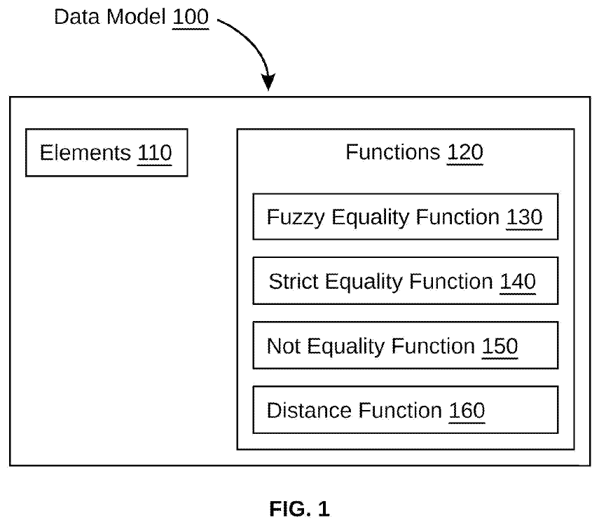

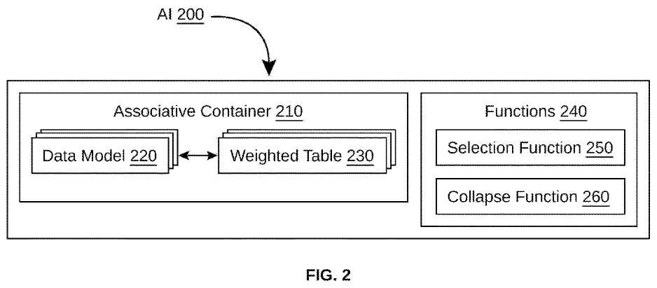

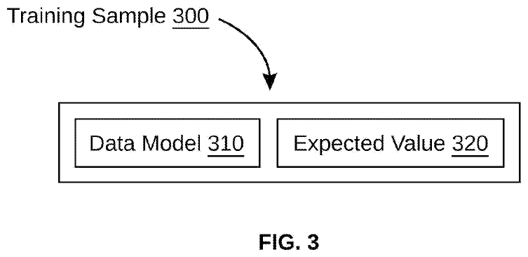

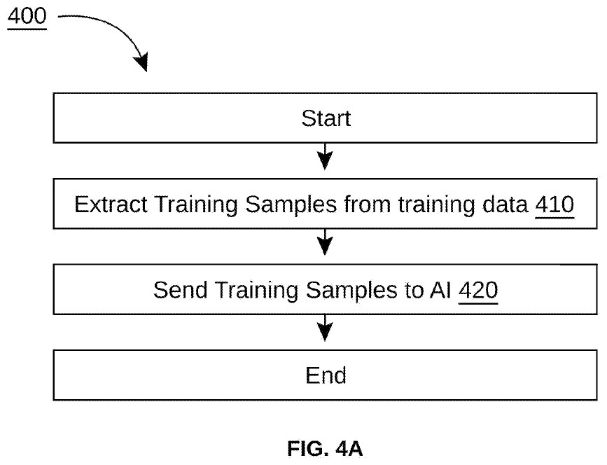

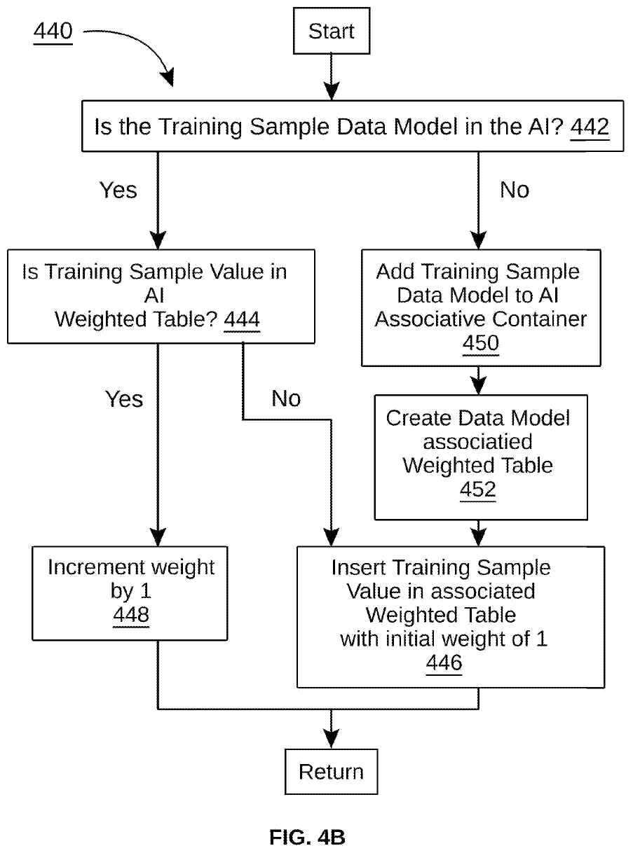

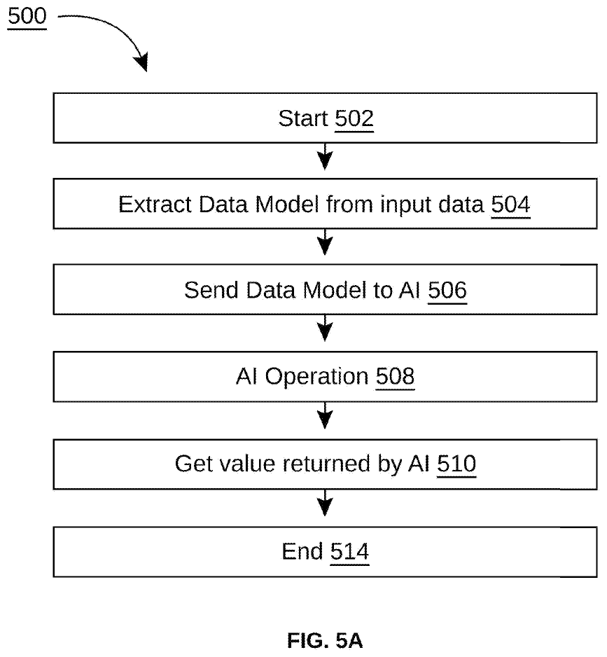

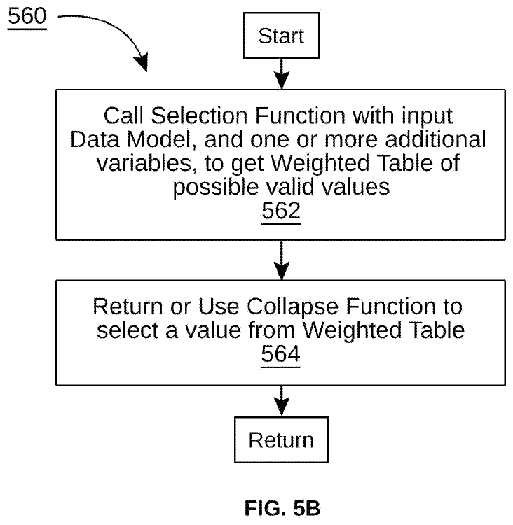

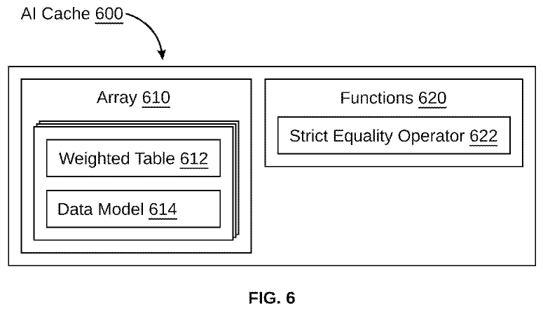

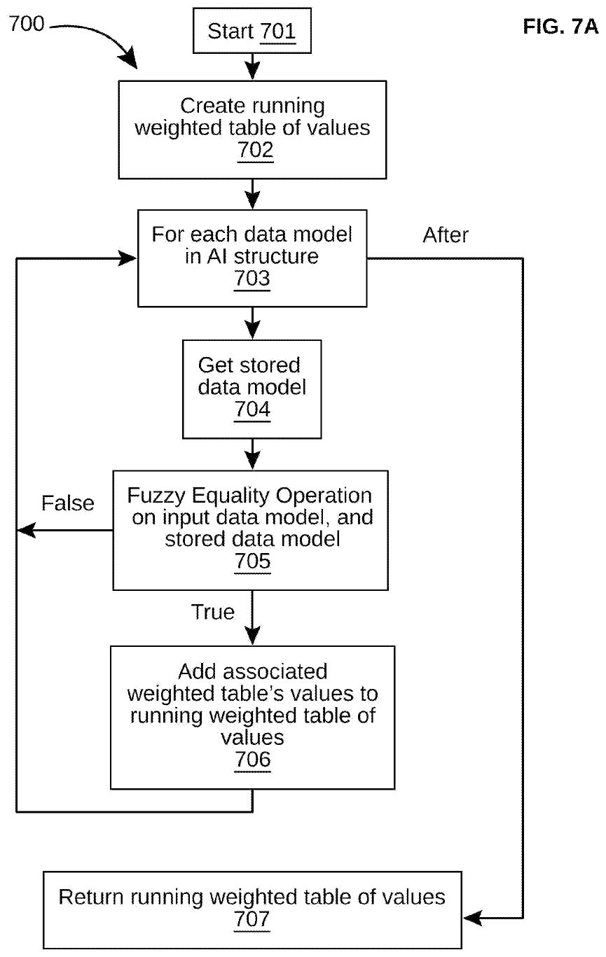

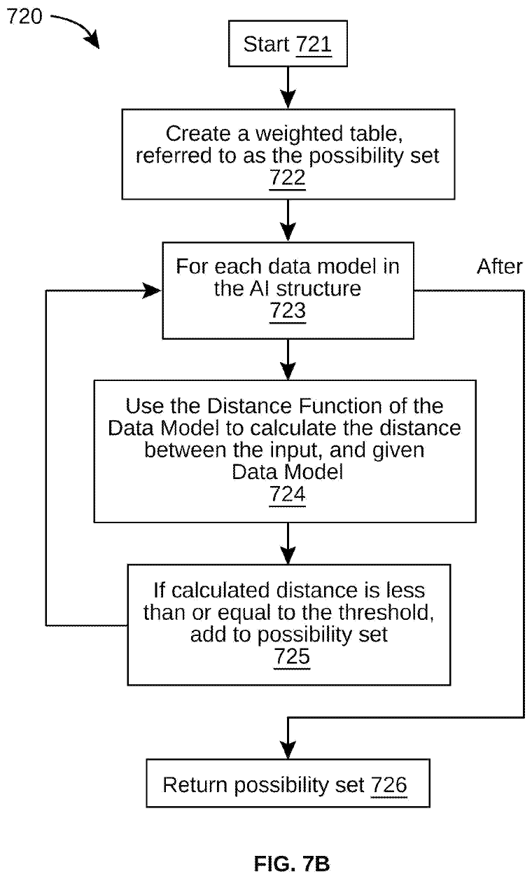

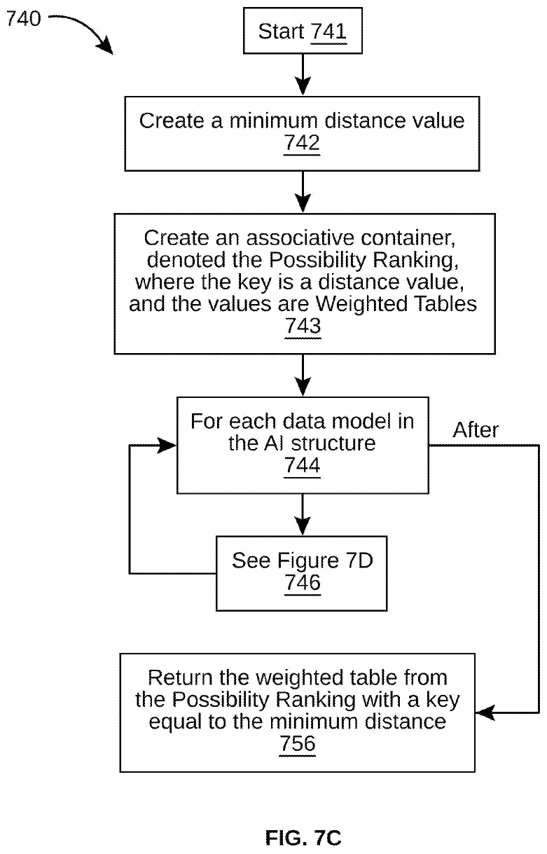

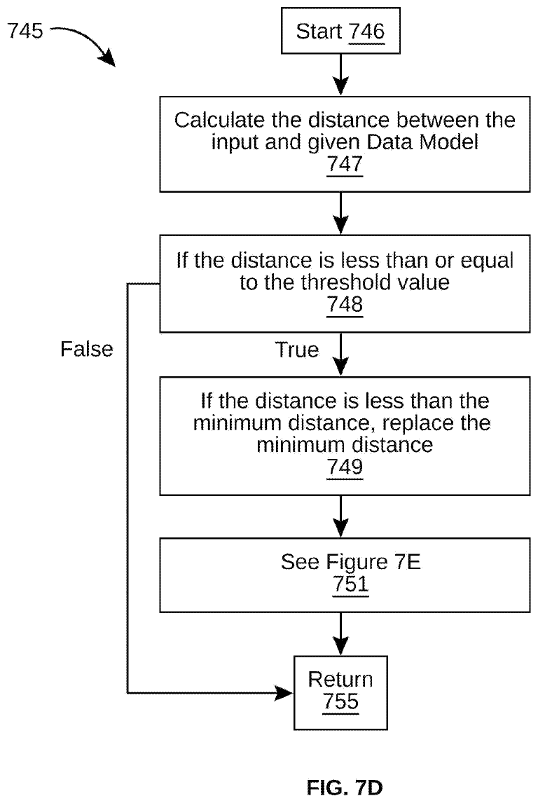

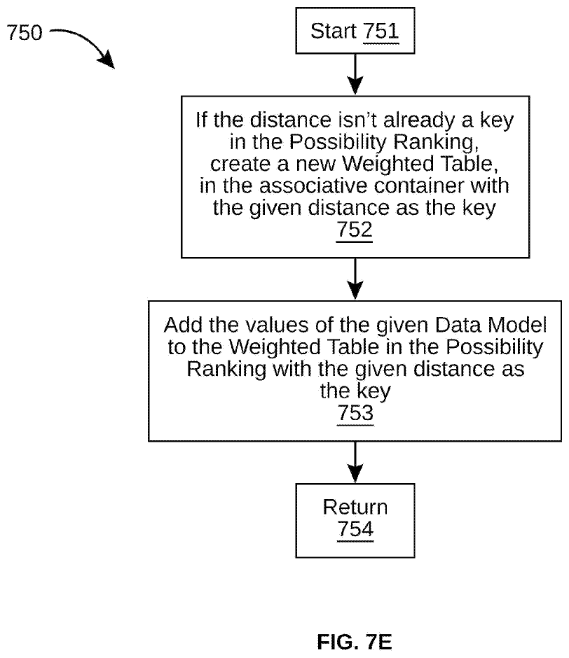

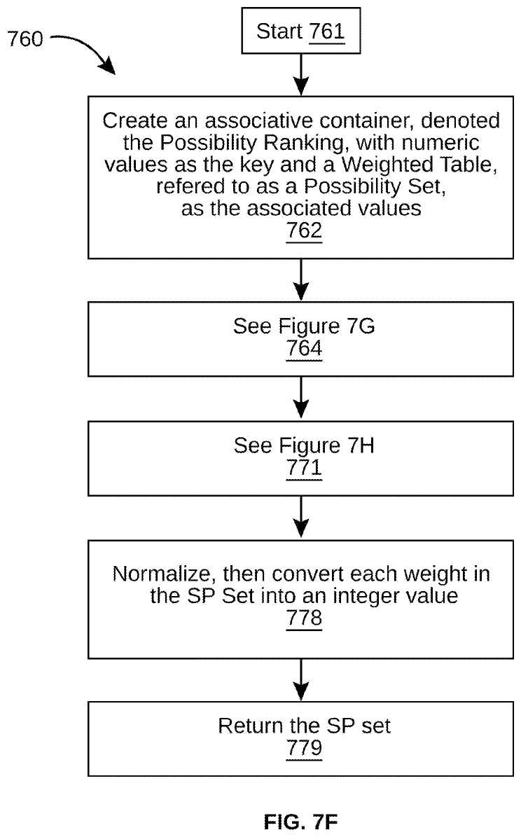

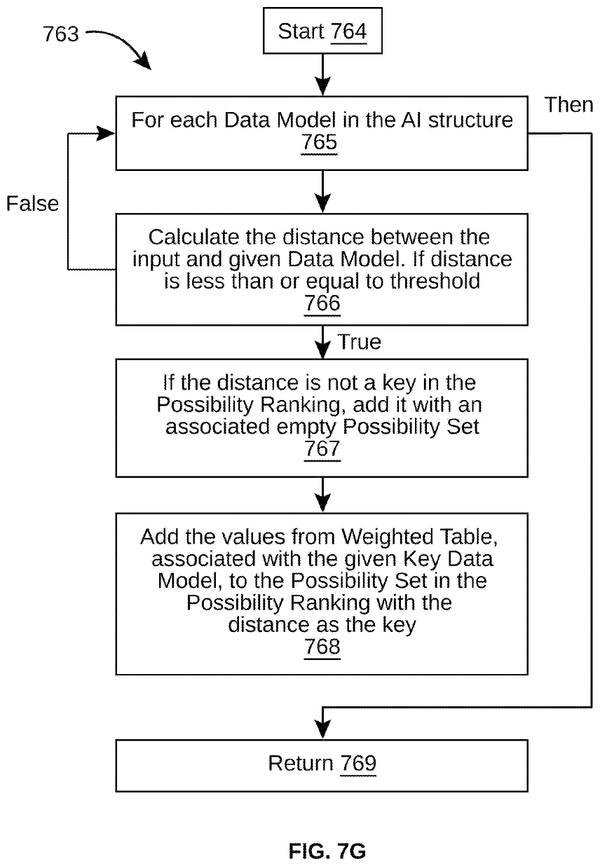

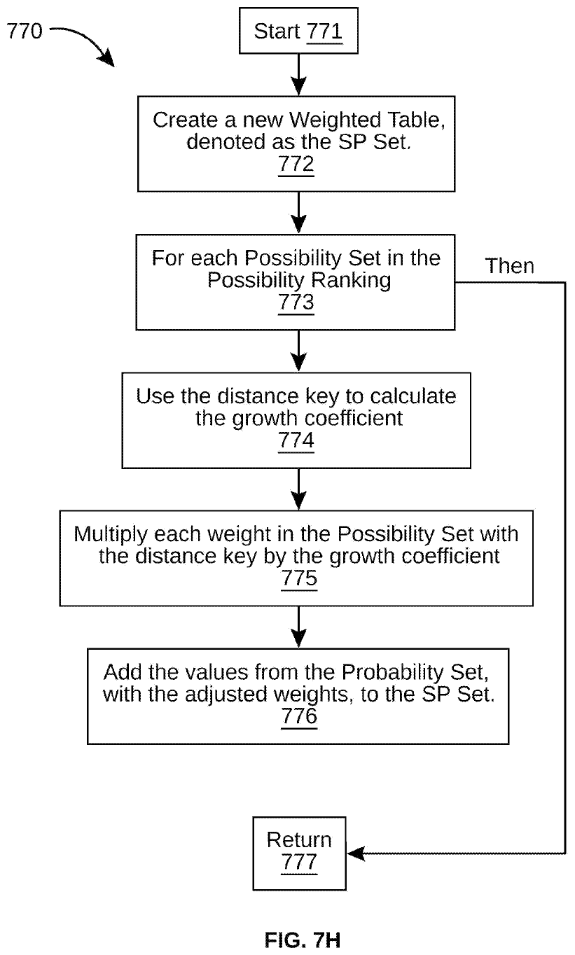

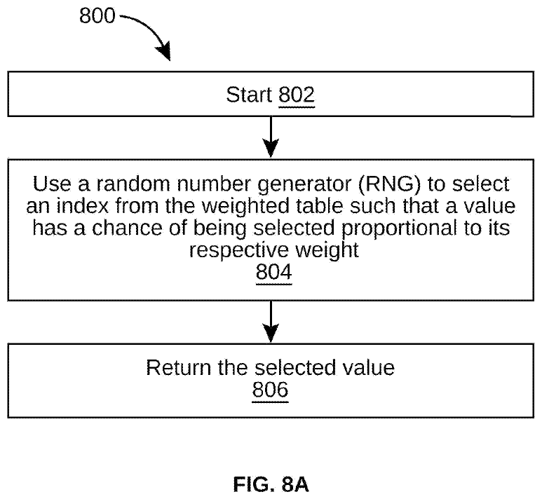

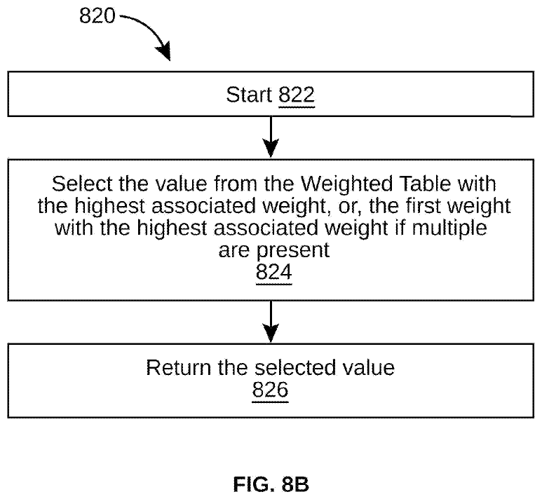

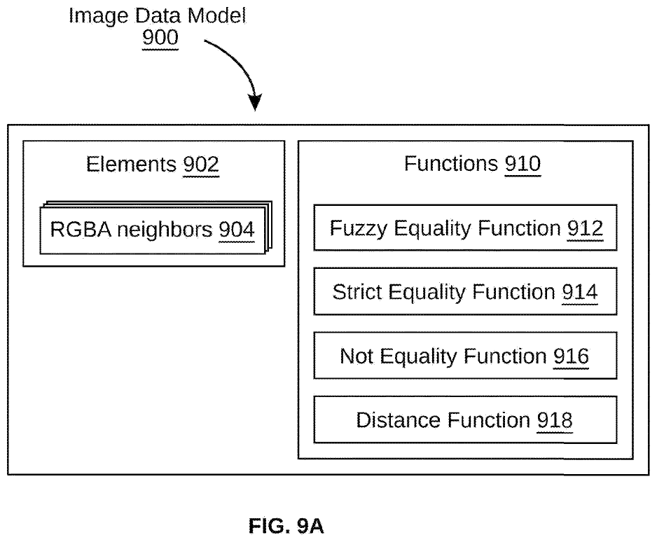

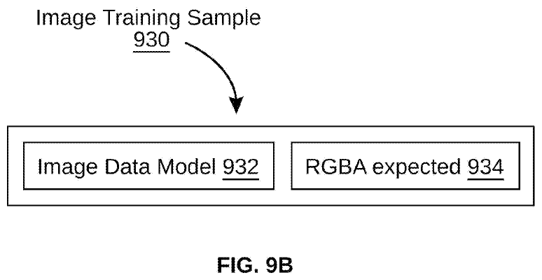

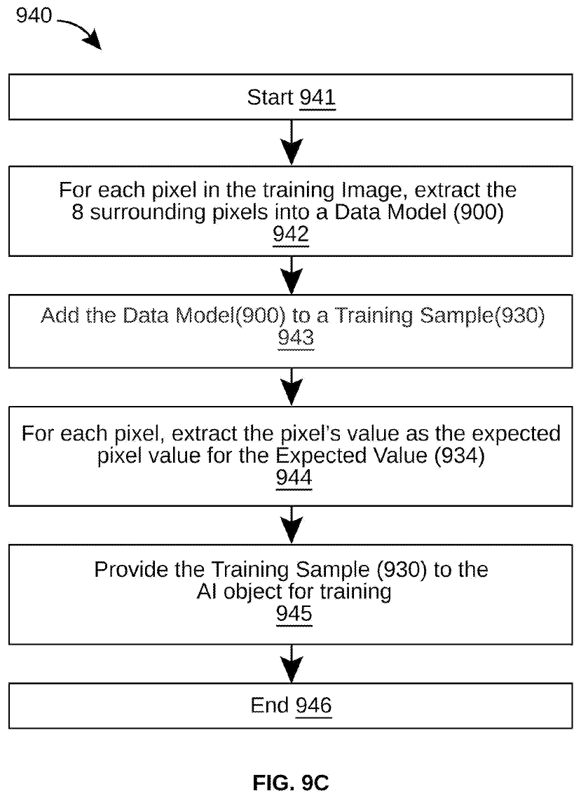

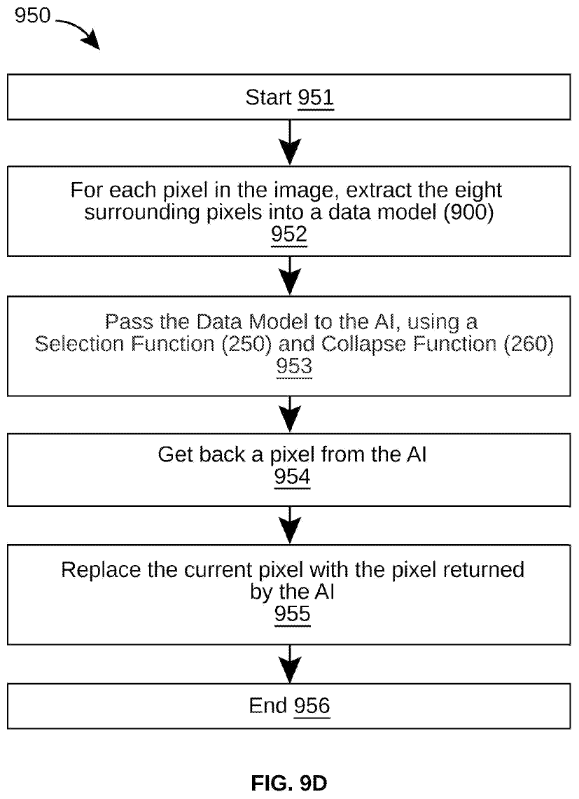

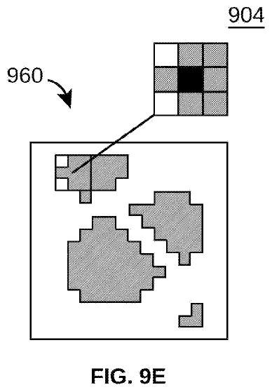

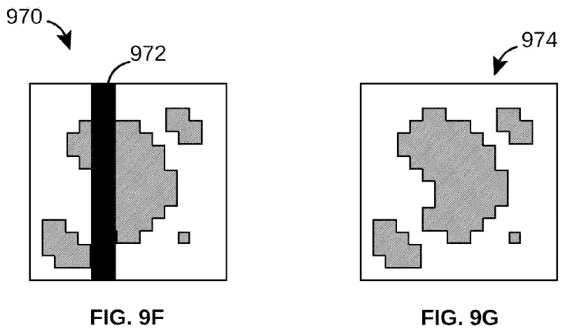

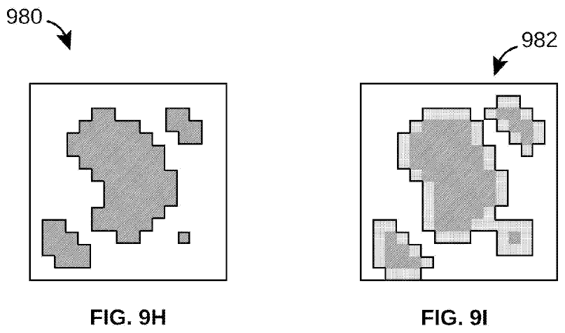

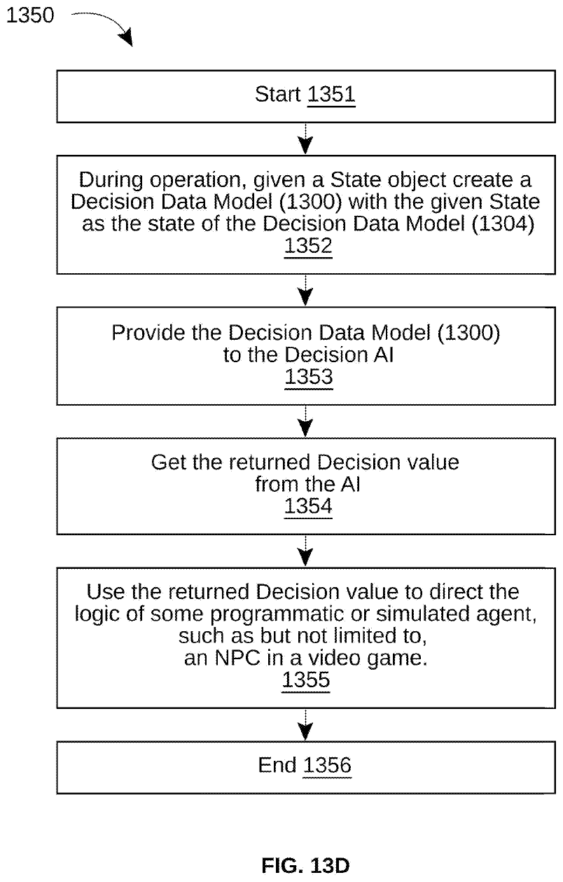

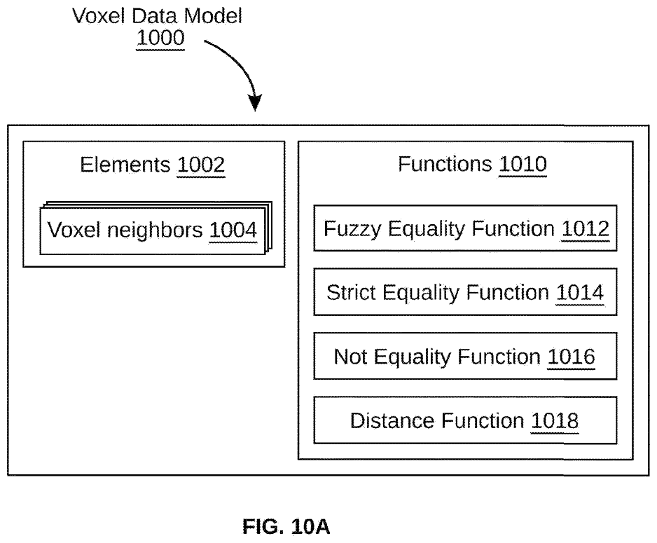

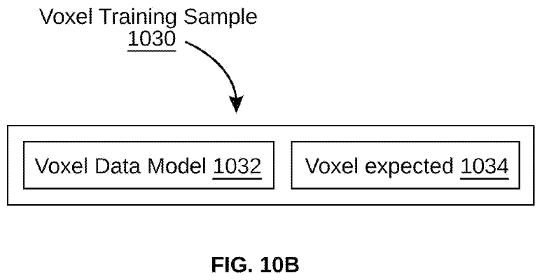

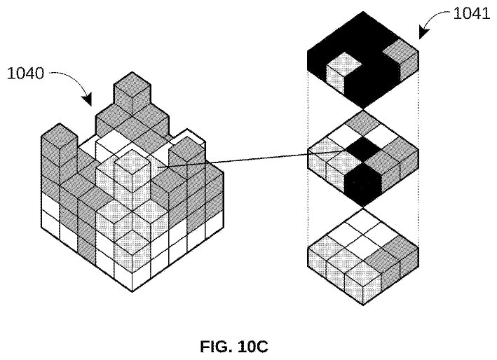

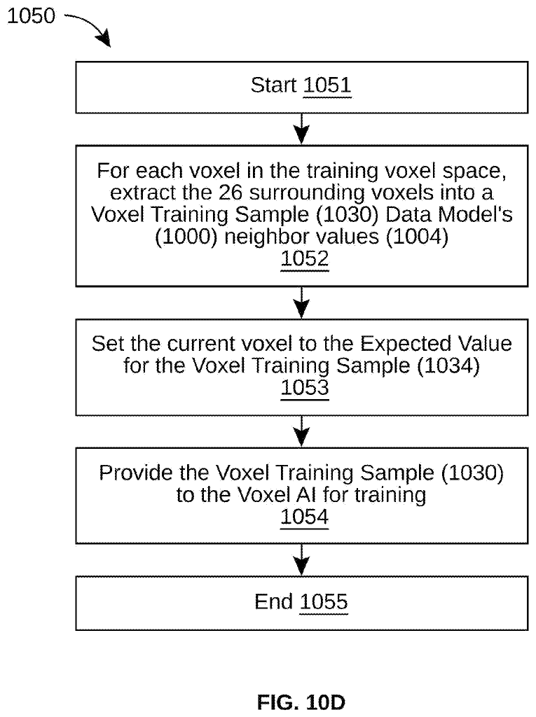

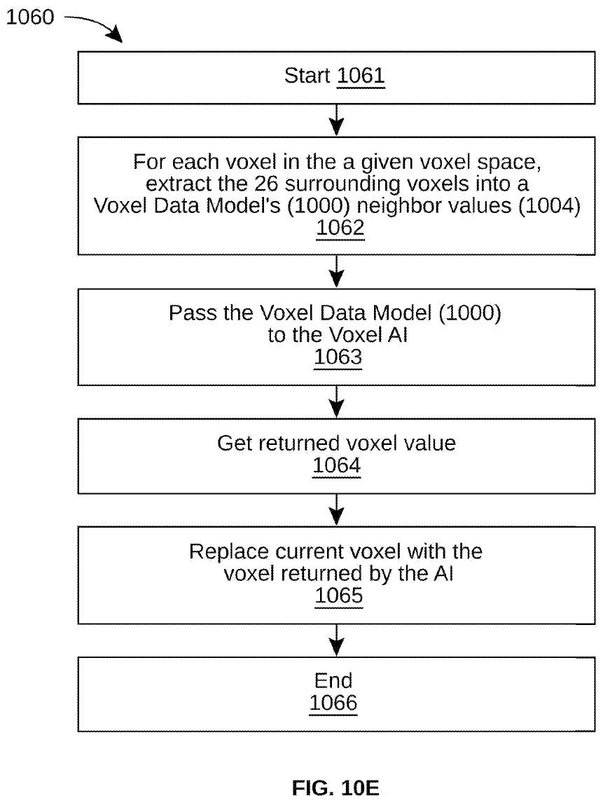

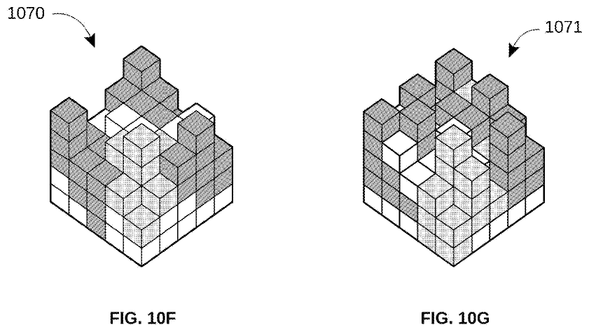

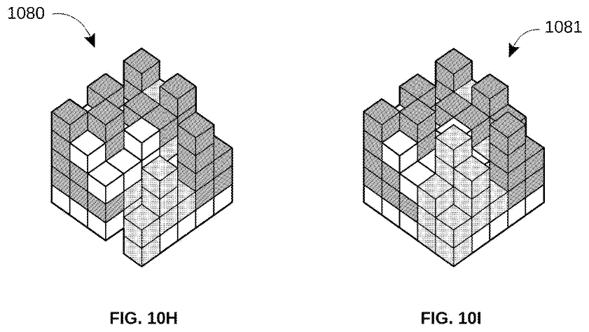

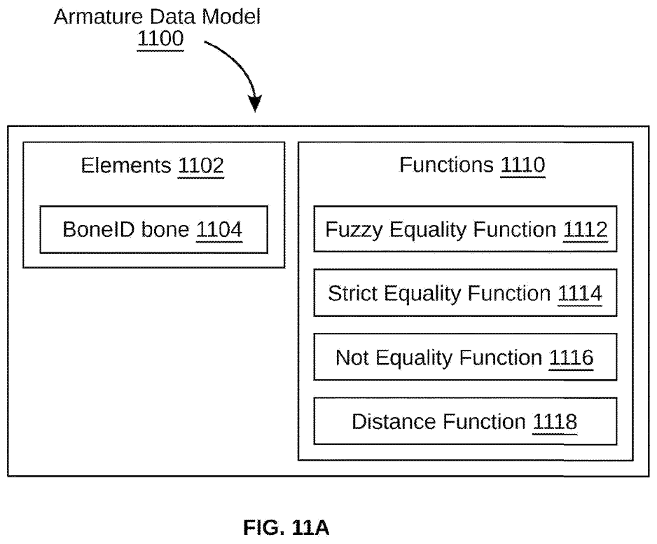

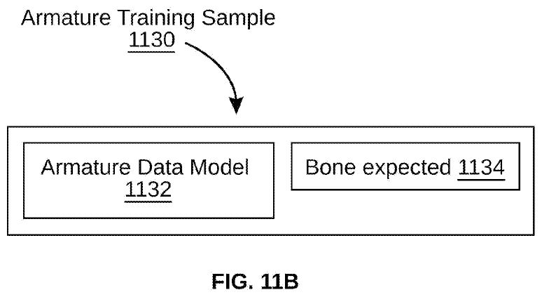

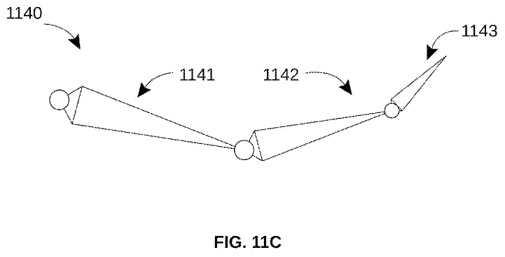

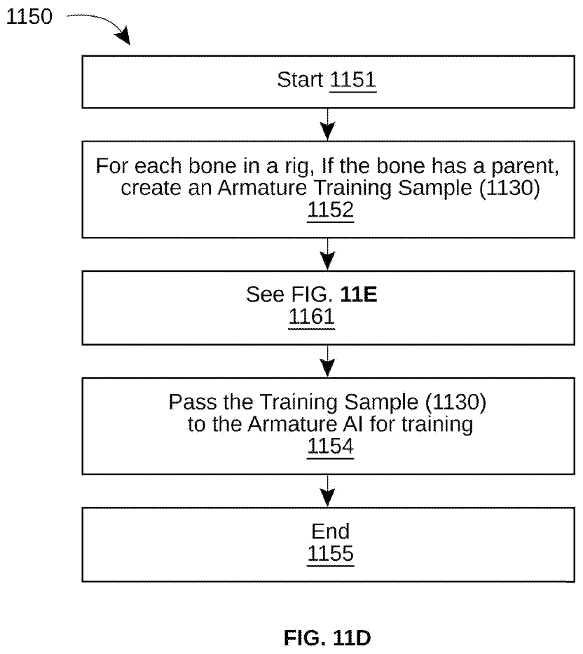

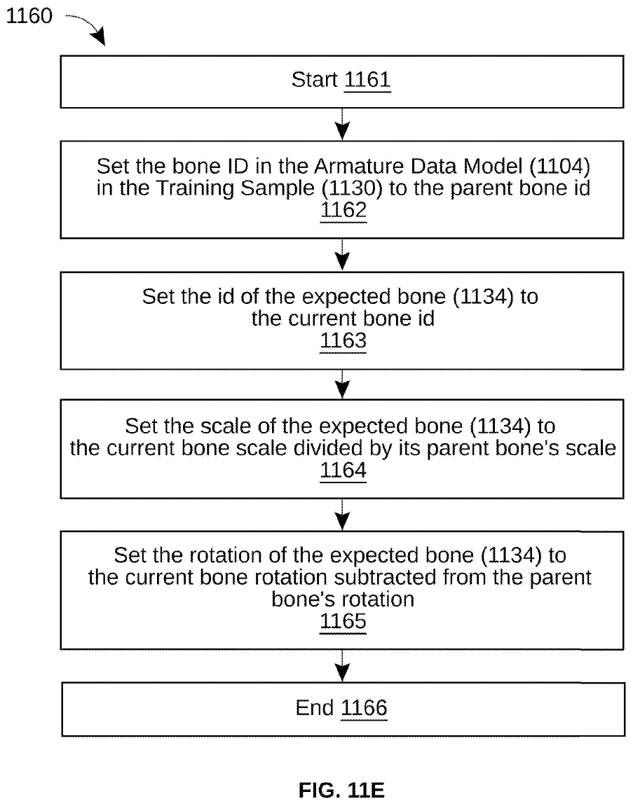

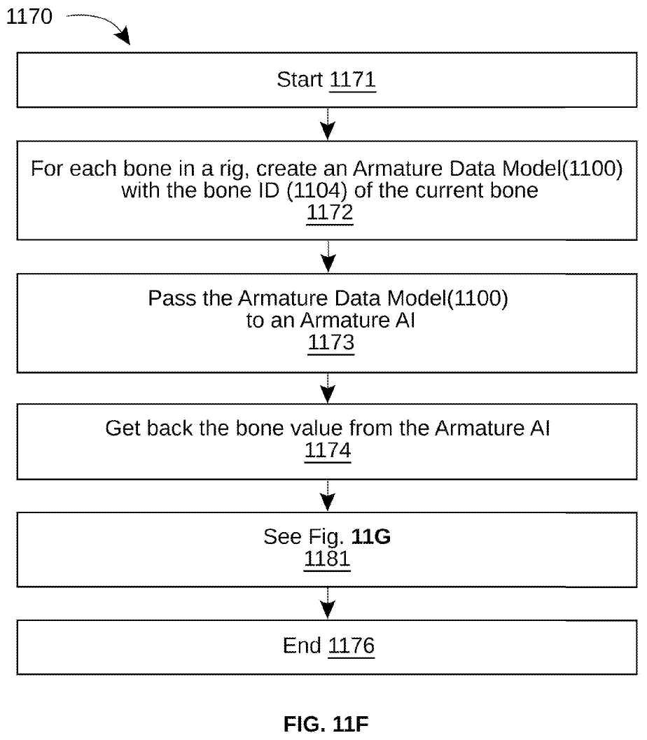

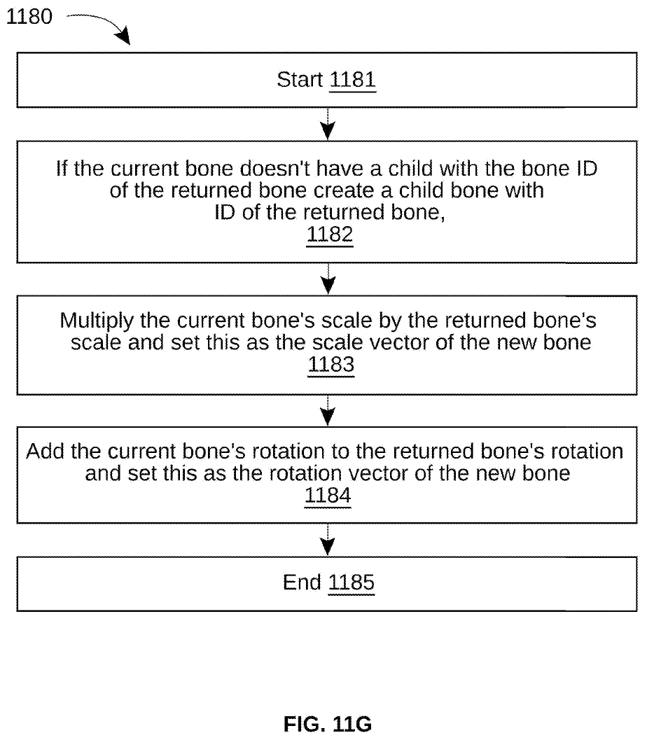

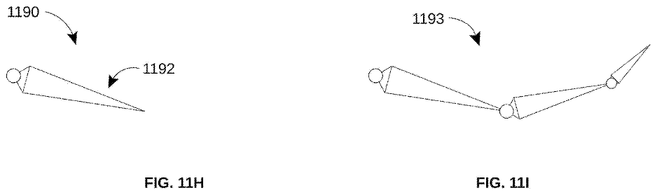

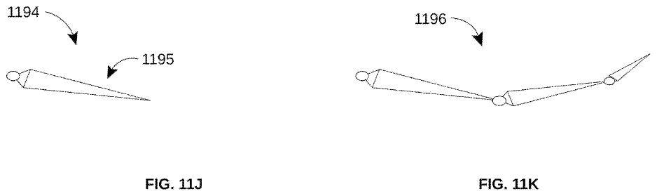

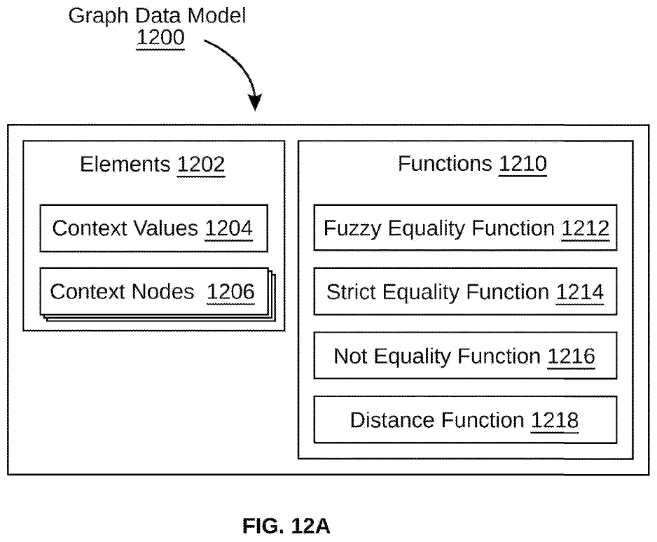

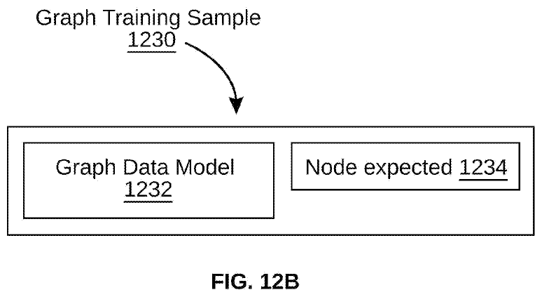

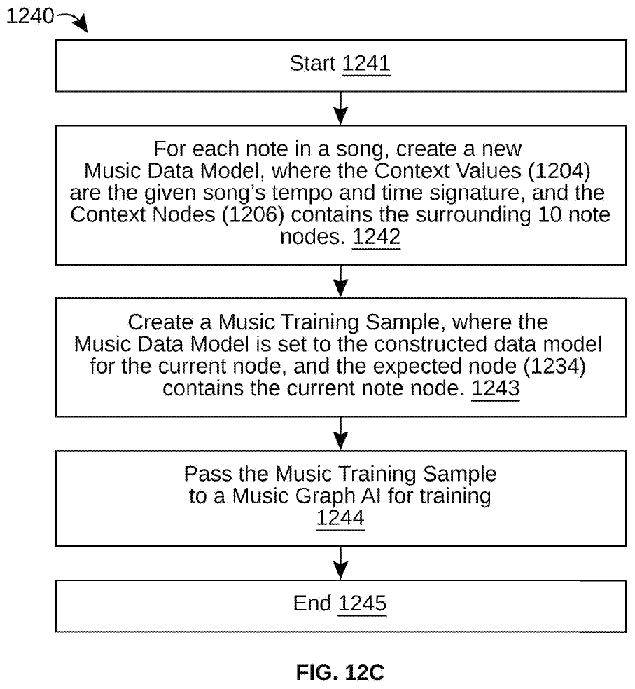

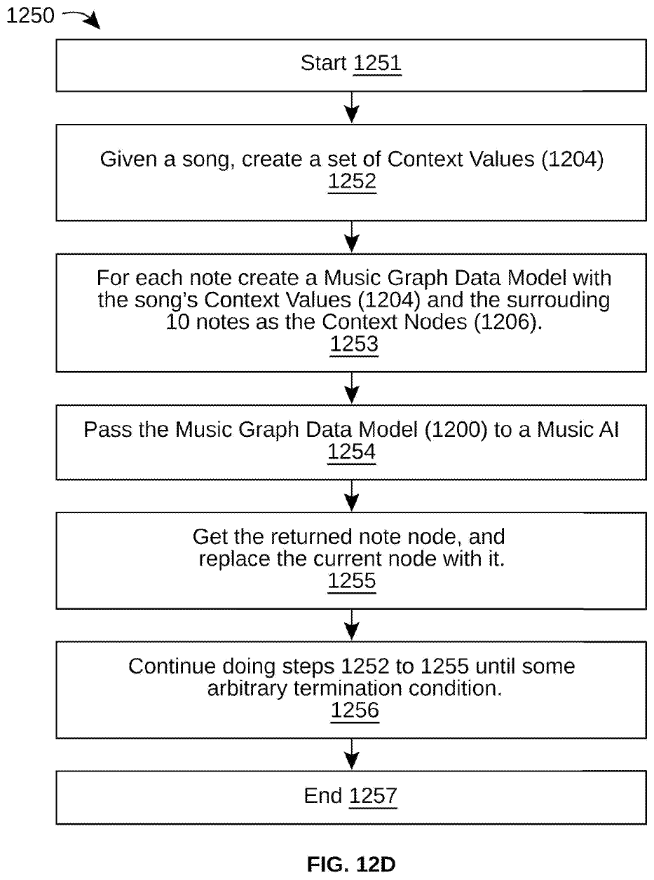

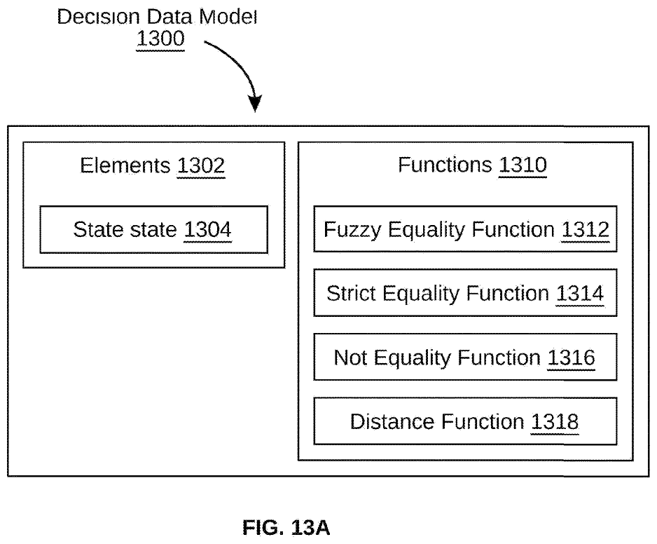

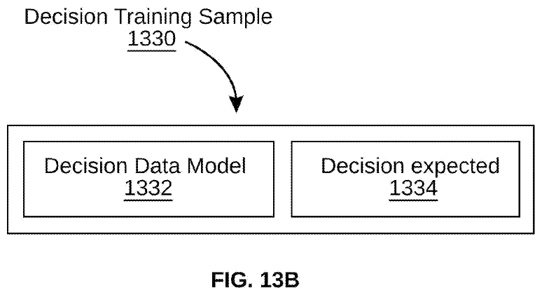

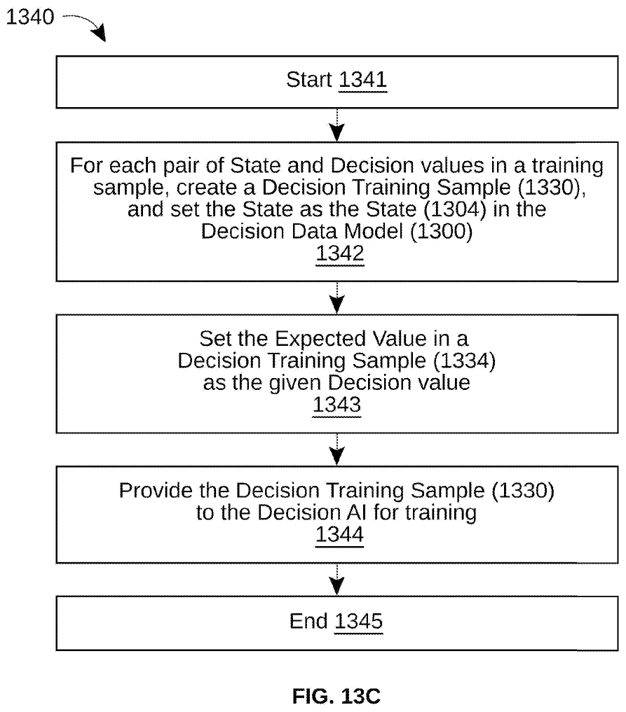

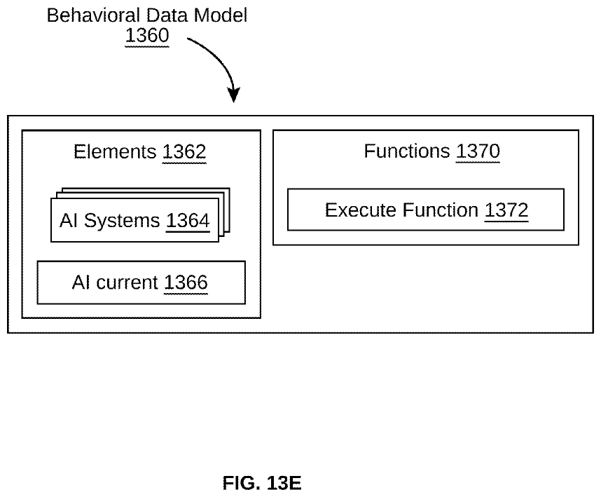

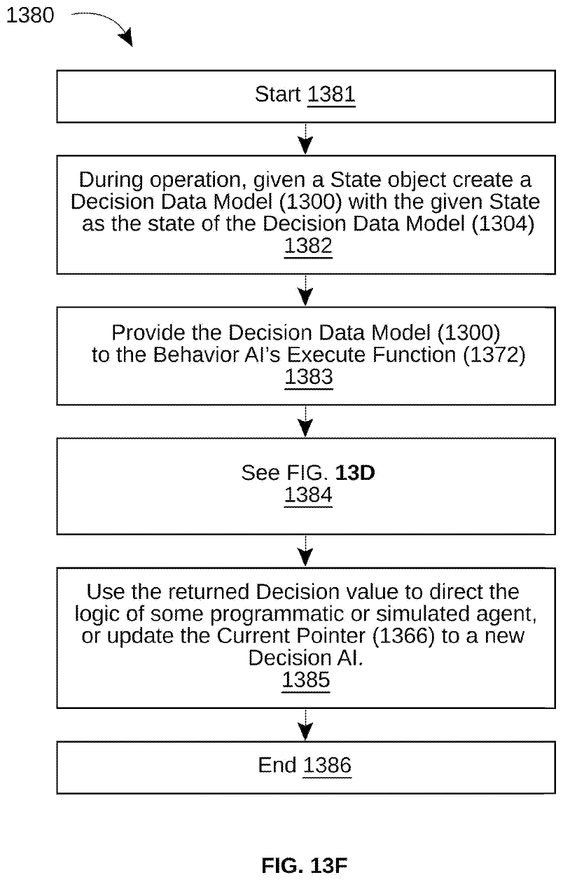

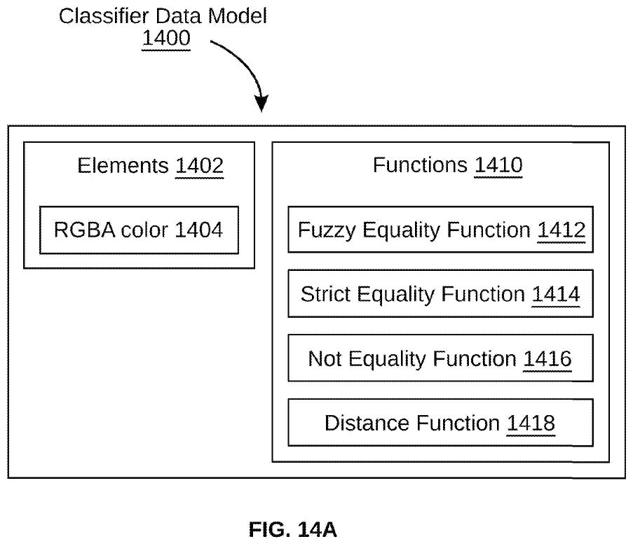

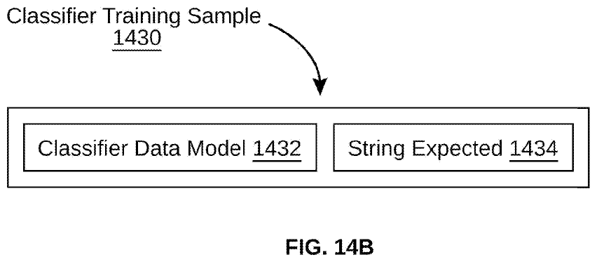

### REFERENCE NUMERALS IN THE DRAWINGS

100 a general Data Model structure.
110 the data elements of a Data Model structure (100), which, in alterations of may comprise a plurality of arbitrary data values of arbitrary data types.
120 listing of functions of a Data Model structure (100), comprised of but limited to, a Fuzzy Equality Function (130), a Strict Equality Function (140), a Not Equality Function (150) and a Distance Function (160).
130 a Fuzzy Equality Function of the Data Model (100).
140 a Strict Equality Function of the Data Model (100).
150 a Not Equality Function of the Data Model (100).
160 a Distance Function of the Data Model (100).
200 an AI data structure.
210 an Associative Container inside of an AI data structure, with Data Models (100) as the key (220) and Weighted Tables as the value (230).
220 key Data Models in an AI Associative Container (210).
230 value Weighted Tables in an Associative Container (210).
240 a collection comprising of, but not limited to, functions in an AI structure (210).
250 a Selection Function in an AI structure (210).
260 a Collapse Function in an AI structure (210).
300 a Training Sample structure.
310 a Data Model (100) as part of a Training Sample (300) structure.
320 an Expected Value of arbitrary data type as part of a Training Sample (300) structure.
600 an AI Cache data structure, which may optionally be added to an AI data structure (200) to accelerate the operation of the AI.
610 an array data structure, containing a plurality of data elements, in the AI Cache (600).
612 a Weighted Table in the AI Cache (600) associated with a Data Model (614).
614 a Data Model in the AI Cache (600) associated with a Weighted Table (612).
620 a collection of functions for the AI Cache (600), comprising but not limited to a Strict Equality Operator (622).
   622 a Strict Equality Operator function for the AI Cache (600).
   900 a specialized embodiment of a Data Model structure (100) for operation on 4-channel, 32-bit, two-dimensional image data structures, referred to as an Image Data Model.
   902 a collection of data elements (110) for the Image Data Model (900) comprising of, but not limited to, a plurality of pixels with specific identifiers (904).
   904 a plurality of pixels with specific identifiers in an Image Data Model (900).
   910 a plurality of functions based on the Data Model functions (120), specialized for operating on the Image Data Model (900) elements (902), comprising of but not limited to, a Fuzzy Equality Function (912) analogous to 130, a Strict Equality Function (914) analogous to 140, a Not Equality Function (916) analogous to 150, and a Distance Function (918) analogous to 160.
   912 a Fuzzy Equality Function of the Data Model (900).
   914 a Strict Equality Function of the Data Model (900).
   916 a Not Equality Function of the Data Model (900).
   918 a Distance Function of the Data Model (900).
   930 a specialized embodiment of a Training Sample (300) for operation on two-dimensional image data structures, referred to as an Image Training Sample.
   932 an Image Data Model (900) specialization of the Data Model in a Training Sample (310), in an Image Training Sample (930).
   934 a specialization of an Expected Value (320) for an Image Training Sample (930) comprised of a color data value.
   960 an image with a plurality of pixels (904) for an Image Data Model (900) being extracted from it.
   970 an example image with missing pixels.
   972 a column of missing or damaged pixels.
   974 an example image (970) after an Image AI is employed to replace the damaged pixels (972).
   980 an example image.
   982 an example image (980) after an Image AI is employed to replace each pixel, which may or may not result in a different pixel in each location.
   1000 a specialized embodiment of a Data Model structure (100) for operation on a three-dimensional voxel space data structure, referred to as a Voxel Data Model.
   1002 a collection of data elements (110) for the Voxel Data Model (1000) comprising of, but not limited to, a plurality of voxels with specific identifiers (1004).
   1004 a plurality of voxels with specific identifiers in a Voxel Data Model (1000).
   1010 a plurality of functions based on the Data Model functions (120), specialized for operating on the Image Data Model (1000) elements (1002), comprising of but not limited to, a Fuzzy Equality Function (1012) analogous to 130, a Strict Equality Function (1014) analogous to 140, a Not Equality Function (1016) analogous to 150, and a Distance Function (1018) analogous to 160.
   1012 a Fuzzy Equality Function of the Voxel Data Model (1000).
   1014 a Strict Equality Function of the Voxel Data Model (1000).
   1016 a Not Equality Function of the Voxel Data Model (1000).
   1018 a Distance Function of the Voxel Data Model (1000).
   1030 a specialized embodiment of a Training Sample (300) for operation on three-dimensional voxel data structures, referred to as a Voxel Training Sample.
   1032 a Voxel Data Model (1000) specialization of the Data Model in a Training Sample (310), in a Voxel Training Sample (1030).
   1034 a specialization of an Expected Value (320) for a Voxel Training Sample (1030) comprised of a voxel value.
   1040 an arbitrary voxel space, with a plurality of voxels (1041) for a Voxel Data Model (1000) being extracted from it.
   1041 an extracted plurality of 26 voxels, being extracted into a Voxel Data Model (1000).
   1070 an example voxel space.
   1071 the previous voxel space (1070) after a Voxel AI was employed on it to replace voxel values according to training.
   1080 an example voxel space with a missing region of voxels.
   1081 the previous voxel space (1080) after a Voxel AI was employed to replace the missing voxels.
   1100 a specialized embodiment of a Data Model structure (100) for operation on 3D armature systems, denoted an Armature Data Model.
   1102 a collection of data elements (110) for the Armature Data Model (1100)
   comprising, but not limited to, a bone identifier value (1104).
   1104 a bone identifier value.
   1110 a plurality of functions based on the Data Model functions (120), specialized for operating on the Armature Data Model (1100) elements (1102), comprising of but not limited to, a Fuzzy Equality Function (1112) analogous to 130, a Strict Equality Function (1114) analogous to 140, a Not Equality Function (1116) analogous to 150, and a Distance Function (1118) analogous to 160.
   1112 a Fuzzy Equality Function of the Armature Data Model (1100).
   1114 a Strict Equality Function of the Armature Data Model (1100).
   1116 a Not Equality Function of the Armature Data Model (1100).
   1118 a Distance Function of the Armature Data Model (1100).
   1130 a specialized embodiment of a Training Sample (300) for training an AI structure (200) for operation on 3D armature systems.
   1132 an Armature Data Model (1100) specialization of the Data Model in a Training Sample (310), in an Armature Training Sample (1130).
   1134 a specialization of an Expected Value (320) for an Armature Training Sample (1130) comprised of a bone object.
   1140 an example armature rig, comprising of three bones, with the identifiers of humerus (1141), ulna (1142) and hand (1143).
   1141 a bone in an example armature rig (1140), with a bone identifier of “humerus”, scale of (1,1,1), rotation of (−15,0,0), with one child bone, denoted the “ulna” (1142).
   1142 a bone in an example armature rig (1140), with a bone identifier of “ulna”, scale of (0.8, 0.8, 0.8), relative rotation of (30, 0, 0), a parent bone with identifier “humerus” (1141) and with one child bone, denoted the “hand” (1143).
   1143 a bone in an example armature rig (1140), with a bone identifier of “hand”, scale of (0.4, 0.4, 0.4), relative rotation of (30, 0, 0), a parent bone with identifier “ulna” (1142) and with no children bones.
   1190 an example armature rig comprised of a single bone, with a bone identifier of “humerus” (1192).
   1192 a bone in an example armature rig (1190), with identifier “humerus”.
   1193 an example armature rig which has been generated from a prior armature rig (1190) after the application of an Armature AI, comprised of 3 bones.
   1194 an example armature rig comprised of a single bone, with a bone identifier of “humerus” (1195), which has a scale of (1.5, 1, 1), referred to as “non-uniform” due to the first component of the scale vector being different from the remaining components.
   1195 a bone in an example armature rig (1194), with identifier “humerus”.
   1196 an example armature rig which has been generated from a prior armature rig (1194) after the application of an Armature AI, comprised of 3 bones.
   1200 a specialized embodiment of a Data Model structure (100) for operation on a topological graph structure with nodes containing arbitrary data, referred to as a Graph Data Model.
   1202 a collection of data elements (110) for the Graph Data Model (1200) comprising of, but not limited to, a collection of one or more contextual values (1204) and a collection of one or more node reference values (1206).
   1204 a plurality of contextual values for use in a Graph Data Model (1200).
   1206 a plurality of topological graph node object references for use in a Graph Data Model (1200).
   1210 a plurality of functions based on the Data Model functions (120), specialized for operating on the Graph Data Model (1200) elements (1202), comprising of but not limited to, a Fuzzy Equality Function (1212) analogous to 130, a Strict Equality Function (1214) analogous to 140, a Not Equality Function (1216) analogous to 150, and a Distance Function (1218) analogous to 160.
   1212 a Fuzzy Equality Function of the Graph Data Model (1200).
   1214 a Strict Equality Function of the Graph Data Model (1200).
   1216 a Not Equality Function of the Graph Data Model (1200).
   1218 a Distance Function of the Graph Data Model (1200).
   1230 a specialized embodiment of a Training Sample (300) for operation on a topological graph structure with nodes containing arbitrary data, referred to as a Graph Training Sample.
   1232 a Graph Data Model (1200) specialization of the Data Model in a Training Sample (310), in a Graph Training Sample (1230).
   1234 a specialization of an Expected Value (320) for a Graph Training Sample (1030) comprised of a node structure containing arbitrary data values.
   1300 a specialized embodiment of a Data Model structure (100) for dynamic decision making systems, denoted a Decision Data Model.
   1302 a collection of data elements (110) for the Decision Data Model (1300) comprising, but not limited to, an arbitrary state object (1304).
   1304 a state object with specific identifiers in a Decision Data Model (1300).
   1310 a plurality of functions based on the Data Model functions (120), specialized for operating on the Decision Data Model (1300) elements (1302), comprising of but not limited to, a Fuzzy Equality Function (1312) analogous to 130, a Strict Equality Function (1314) analogous to 140, a Not Equality Function (1316) analogous to 150, and a Distance Function (1318) analogous to 160.
   1312 a Fuzzy Equality Function of the Decision Data Model (1300).
   1314 a Strict Equality Function of the Decision Data Model (1300).
   1316 a Not Equality Function of the Decision Data Model (1300).
   1318 a Distance Function of the Decision Data Model (1300).
   1330 a specialized embodiment of a Training Sample (300) for training an AI structure (200) to for dynamic decision making systems.
   1332 a Decision Data Model (1300) specialization of the Data Model in a Training Sample (310), in a Decision Training Sample (1330).
   1334 a specialization of an Expected Value (320) for a Decision Training Sample (1330) comprised of a Decision object.
   1360 a specialized embodiment of a finite state automata for employing multiple Decision Data Models (1300) in sophisticated dynamic decision making systems, denoted as a Behavioral Data Model.
   1362 a collection of data elements (110) for the Behavioral Data Model (1360).
   1364 a plurality of Decision Data Model (1300) objects.
   1366 a software reference to a specific Decision Data Model (1300) indicating the Decision Data Model (1300) currently considered as the state of the Behavioral Data Model (1360).
   1370 a single function denoted as Execute Function (1372) for operation on a Behavioral Data Model (1360) in an iterative manner.
   1372 the Execute Function of a Behavioral Data Model (1360).
   These and other aspects of the present invention will become apparent upon reading the following detailed description in conjunction with the associated drawings.

### DETAILED DESCRIPTION

### Description of the Transformation Process

Although the following detailed description contains many specifics for the purposes of illustration, anyone of ordinary skill in the Art will appreciate that many variations and alterations to the following details are within the scope of the invention. Accordingly, the following embodiments of the invention are set forth without any loss of generality to, and without imposing limitations upon, the claimed invention.

A Decision AI or Behavior AI, collectively referred to hereafter as “Agent AI”, may be used in a wide variety of applications. However, many existing systems and applications have been constructed with regards to previously existing methods, such as, but not limited to, hard-coded logic, behavioral trees, and finite state machines, herein abbreviated as FSMs. In addition, some technologies, due to constraints, for example, available on-system memory, or mathematical mechanisms, may require more traditional approaches to their controlling logic so as to continue to function reliably. As such, it is of some benefit to be able to transform a given AI as it pertains to the invention, in particular Agent AI, into an alternative representation of the types employed in these traditional systems.

It will be of some benefit to expand on terminology pertaining to common tree data structures as they pertain to the representation and execution of logic. A tree is a hierarchical data structure comprised of a plurality of node elements with arbitrary associated data. Additionally, some types of trees also possess a plurality of edge elements which contain references to various node elements, and, optionally, additional data elements, representing the relationship between two or more nodes. Generally, each node is said to be at some level in the hierarchy of a tree, possessing edges relating it to nodes considered higher or lower in the hierarchy, referred to as the node's “parents”, and edges relating to nodes considered lower in the hierarchy, referred to as the node's “children”. In a given tree there is often a single node which has no relative parent nodes, commonly denoted as the “root node” or merely “root”. In a given tree there may be one or more node elements which possess no additional child elements, making them the lowest-level elements in the hierarchy, denoted as “leaf nodes”. The relationship between two nodes, where one node is in an immediately adjacent but different hierarchical level than the other, is said to be a “parent-child” relationship, where the “parent” is the node in the higher hierarchical position, and the child the node in the lower hierarchical position. The relationship between two nodes, where one node is either an adjacent or non-adjacent child of the other is a “descendant” relationship, with the node which is of lower hierarchical position being denoted as the “descendent” of the other node. The relationship between two nodes which exist in the same level of the hierarchy is referred to as a “sibling” relationship, and the nodes are said to be “siblings” of each other.

In the Art there exists a number of methods for combining two or more trees, referred to herein as “Tree Merging” methods. The following description is a specific embodiment of a Tree Merging method. However, it will be recognized by anyone skilled in the Art, that a number of alterations and methods exist which achieve a similar result. As such it will be clear to anyone of ordinary skill in the Art, that the Invention as described herein may be easily altered such that any such tree merging method may be employed while the nature of the invention remains the same, and therefore falls within the Scope of the Invention.

First, given two trees, the root node of the second tree is found within the first tree, and set as the current node. Then the merge process begins. For each child of the current node version found in the second tree, it is checked if a corresponding child node is found in the current tree. If a corresponding child node is not found in the current tree, the node from the second tree and all of its children, and their descendants are recursively added to the tree by attaching the node to the current node as a child. Otherwise, if a corresponding child node is found in the current tree, the merge process is executed on it, resulting in a recursive process. Upon completion of a given merge process, the next sibling node is moved too. Upon the completion of all merge processes, this will result in the first tree now having the structure of the second tree merged into it.

A specific class of tree denoted as a “logical tree”, is a tree data-structure where the data associated with each node element is some manner of arbitrary logical element which facilitates the execution of some arbitrary function or logic in a software application. A node with associated arbitrary functions or logic is denoted as a “logical node”.

An Abstract Syntax Tree, herein referred to by the abbreviation AST, is a model and corresponding software technique for representing the structure of a program in the form of a logical tree. In an AST the data associated with a given node element represents some form of basic logical operation, such as but not limited to, for example, the comparison of two values and choice to proceed with one course of operation or another depending on the result of the comparison operation. An AST may be considered as a computable representation of the textual form of software, herein referred to as “source code”, and are commonly employed in the Art as a model thereof. In the Art it is common to employ automated software, such as, but not limited to, a lexical analysis system, denoted as a “lexer”, “compiler” or “transpiler”, to convert the source code representation of a program into an AST before performing logical operations on the AST to alter the behavior of the program in some manner, such as, but not limited to improving the performance of the software. After an AST has been altered, an additional software component, commonly referred to in the art as an “interpreter”, may be used to carry out the logical steps of the program, thereby producing the software application represented by the original source code. The process of converting a source code representation into an AST, then carrying out the logical instructions to produce the defined software application is commonly referred to in the Art as “interpreted execution”. Alternatively, an additional software component, sometimes referred to as a “bytecode generator”, may be employed to convert the AST into a binary representation that may be written to computer memory, and later loaded into computer memory to execute the program represented by the original source code in a process herein referred to as “compiled execution”. These methods are the most common in the Art for the production and performance of software applications in computing devices, such as, but not limited to, personal computers, mobile computing devices, and embedded computing devices such as those found smart-watches, robotic devices, autonomous vehicles, electrical appliances, and most non-trivial electrical devices.

A Decision Tree, herein referred to by the abbreviation DT, is a model and corresponding software technique for representing a multi-stage process which produces an output value as a logical tree. A logical node in a DT may have any number of distinct arbitrary logics associated with it. To execute the logic represented by a DT, first the root node is selected. The root node's logic is executed, which will result in an outcome that determines which of the root node's children nodes will be iterated too next. The subsequent node is iterated too, and its logic is executed, resulting in an outcome directing the software to the next child node. If at any point, a leaf node is reached, the node's logic is executed, and the DT is then said to have completed.

A Behavior Tree, herein referred to by the abbreviation BT, is a logical tree model and corresponding software technique for programmatically representing a complex behavior by which a program, or virtual agent within the context of a program, may be controlled, such as, but not limited to, the operation of a software application, control of an electromechanical device such as, but not limited to, an appliance, vehicle or robotic device, or control over a virtual agent within a virtual environment, such as those found in, but not limited to, video games and simulation software. A BT comprises a plurality of logical node elements, each containing an associated arbitrary software logic. It is common for a given BT system to define a number of distinct node types with defined logics, such as, but not limited to, for example, a Sequence Node which executes each of its children nodes in order, a Random Map Node, which randomly selects one of its children nodes to execute the associated logic of, or a Map Node which selects one of its children nodes based on some input value to execute the corresponding logic of. The operation of a BT starts at the root node. First, the logic of the root node is executed, which then must determine which of the node's children nodes are then iterated too. Then, the current node's associated logic is executed, resulting in the subsequent node being iterated too. If a leaf node is reached, its corresponding logic is executed before completing. Depending on the logic of a given node during execution, once its children complete, it may either complete, or perform additional logic to iterate to another node, such as one of its children nodes.

In addition to the standard operation of a Decision AI or Behavior AI, collectively referred to herein as “Agent AI”, a process is presented herein such that, after training or usage of an Agent AI, an Agent AI may be transformed into alternative structures which can drive software behavior in a similar manner to the Agent AI, such as, but not limited to, logical trees.

It will be of benefit to discuss a few types of structures common to a Behavior Tree for the purpose of the invention. Herein a Selector Node refers to a logic node with one or more child nodes, which selects a subsequent child node based on an input value provided to it. A Random Selector Node refers to a logic node with one or more child nodes, which randomly selects a subsequent child node based on a randomly generated numerical value, using an arbitrary random number selection process. A Sequence Node herein refers to a logic node with one or more child nodes, which iterates through each of the child nodes, executing their corresponding logic in-order.

Herein these specific tree structures and corresponding nodes will be employed, but it will be obvious to anyone skilled in the Art, that further additional node-types and structures may be easily produced that are within the scope of the invention. Accordingly, the following method is set forth without any loss of generality to, and without imposing limitations upon, the claimed invention.

First, given an Agent AI, a list, denoted as the “Mappings List” is created. Each pair of data model (220) and weighted-set (230) present in the AI associative container (210) and, if present, AI cache (600) array (610) are added to the mapping list. For each pair of data model and weighted-set in the Mappings List, a new empty BT is created with a place-holder leaf node as the root node. Then, for each element in the corresponding data model, a new selector node is created that takes in a value of the type of the corresponding element. A child leaf node is added to the selector node, such that a value equal to the corresponding element in the data model would result in the leaf node being selected as the subsequent node. The selector node replaces the previous leaf node in the BT. This process is performed iteratively, creating a tree of selector nodes, each with 1 corresponding child node, ending in a place-holder leaf node. Then, an arbitrary method, denoted as a “Collapse Node Function” is employed to transform the corresponding weighted-set into a sub-tree. The sub-tree is then attached to the placeholder leaf node. This creates a completed BT for a single data model. Once a BT is created for each pair of data model and weighted-set, a new empty BT is created denoted as the Running Tree. For each of the generated BTs, Tree Merging is applied between the Running Tree and the given generated BT, merging the generated BT into the Running Tree. Once each generated BT has been merged into the Running Tree, a complete BT based on the SPC has been generated.

The exact Collapse Node Function chosen during generation may be altered to change the generated output tree behavior. As such the exact choice gives a great deal of variety in the potential behavior of the output BT.

Anyone of ordinary skill in the art will appreciate that many variations and alterations of the Collapse Node functions may be easily produced that are within the scope of the invention by altering key aspects of the system and methods described in the invention. Accordingly, the following embodiments are set forth without any loss of generality to, and without imposing limitations upon, the claimed invention.

An embodiment of a Collapse Node Function denoted as “Max Path Collapse” may be employed to produce a logic node which outputs a single value. First, a value denoted as Maximum is initialized to a default value. For each value in the weighted-set, the associated weight is compared to the Maximum value. If the weight is greater than the Maximum, it replaces the Maximum. Once each value has been iterated through, the first value found with a weight equal to the Maximum is returned by the node.

An additional embodiment of a Collapse Node Function denoted as “Min Path Collapse” may be employed to produce a logic node which outputs a single value. First, a value denoted as Minimum is initialized to a default value. For each value in the weighted-set, the associated weight is compared to the Minimum value. If the weight is less than the Minimum, it replaces the Minimum. Once each value has been iterated through, the first value found with a weight equal to the Minimum is returned by the node.

An additional embodiment of a Collapse Node Function denoted as “Sequence Collapse” results in a Sequence Node with additional child nodes for each value in the weighted-set, which may execute some arbitrary operation, such as, but not limited to, addition, subtraction, multiplication or division, on each returned value from the execution of its child nodes before returning the aggregate result.

An additional embodiment of a Collapse Node Function denoted as “Random Selector Collapse” may be employed to produce a logic node which randomly outputs one of many possible values. First a random number generator is employed to generate a number between 0 and the number of children nodes minus 1, such that a value has a chance of its index being generated proportional to its weight. Then the value at the index of the randomly generated number is returned, and the corresponding child node is selected. Then the value of the selected child node is returned.

It will be appreciated by anyone skilled in the Art that a Behavior Tree may also be easily transformed into a Decision Tree or AST, as each is a form of logical tree. As such, the method presented herein may be used to transform an Agent AI into any form of logical tree.

The use of a logical tree representation of an Agent AI has distinct differences in operation from the AI (200) and method of operation presented herein. A tree-representation of an Agent AI is able to be stored and operated in a more resource constrained environment, and in more traditional systems. However, due to the absence of Selection Functions (250), a tree representation loses the ability of an Agent AI to take in arbitrary values and instead must be presented with values which it has distinct rules defined for. In addition, the absence of any Collapse Functions (260), instead deferred for a simpler logical node, reduces the ability for a tree-based system to dynamically change its behavior during execution. In general, many of the advantages and flexibility of an Agent AI and the Invention are lost after the transformation into a tree representation. As such, it is clear that the tree representation is not trivially equitable to the original Agent AI structure.

It is common in the Art to represent logical trees in two forms within software. A logical tree may be represented by a textual representation in the source code of a software application, denoted as “hard-coded” tree. In addition, a logical tree may be represented by a collection of software objects, and constructed from external data sources, denoted as a “data-driven” tree. As such, it will be appreciated by anyone skilled in the Art that a representation in either forms may be considered trivially equal and are covered within the Scope of the Invention.

In addition, any Logic Tree may be transformed from a data-driven representation into a hard-coded representation of the tree's given logic via a category of processes referred to in the Art as “Tree Serialization” methods.

For example, given a simple tree consisting of a Map node which takes in a boolean value of either “true” or “false”, where a value of “true” routes to a leaf node which returns a value of 10, and a value of “false” routes to a leaf node which returns a value of 100, it is possible to represent this in a hard-coded language. First, the boolean condition may be either transformed into a binary conditional statement, commonly referred to in the Art as an “if-else statement”, or a multi-case conditional statement, commonly referred to in the Art as a “switch statement”. Then, each child logic may be transformed into a textual form as what is commonly referred to in the Art as a “return statement”, returning their respective values. It will be appreciated by anyone skilled in the Art, that while this example is specific, it represents an easily modified and generalizable process and the process of transforming an Agent AI to a textual form may be equated to the Logic Tree transformation, and as such is covered by the Scope of the Invention.

A Finite State Machine is another traditional method for creating complex software systems. As such, there are many similar benefits to the process of transforming an AI into a FSM representation, as there are transforming an AI into a logical tree representation.

The following specific method presented herein describes a process for transforming a given Agent AI to an FSM representation. However, it will be clear to anyone skilled in the Art, that the given example may be altered in a wide number of manners, making a comprehensive description of all transformation algorithms impractical. As such the following is presented without any loss to generality or Scope of the Invention.

Given a Decision AI, a simple FSM may be created. First, a list of each data model (220) and associated weighted-set (230) found in the AI associative container (210), and if present, the AI cache (600), is created, denoted as the “Mappings List”. For each pair of data model and weighted-set in the Mappings List, a new state object is created. Additionally, a state-transition function is created which may be employed by all state objects which, given a matching data model as an input parameter, triggers a state transition to the newly constructed corresponding state. In addition to a state transition, each transition function also invokes the logic of the state, which should output some value. A specific function, denoted herein as a “FSM Collapse Function” is used to transform the weighted-set into a simple logical behavior for the state. There are a number of distinct FSM Collapse Functions, each which can alter the exact behavior of the resulting FSM. Once each pair of values has been transformed into a state, a simple FSM representation of the Decision AI has been created.

One embodiment of an FSM Collapse Function, denoted as “Max FSM Collapse”, defines the logic of the state object to return the value from the weighted-set that had the highest weight value associated with it.

Another embodiment of an FSM Collapse Function, denoted as “Min FSM Collapse”, defines the logic of a state object to return the value from the weighted-set that had the lowest weight value associated with it.

Another embodiment of an FSM Collapse Function, denoted as “Weighted Roll FSM Collapse”, defines the logic of a state object to return a value randomly selected from the weighted-set, such that a given value's probability is proportional to the weight associated with that value in the weighted-set at the time of the transformation.

Additionally, given a Behavior AI, a simple FSM may be created with a variation on the previously described method. First, a new list, denoted as the “Mappings List” is created, comprising groups of data model, weighted-set and corresponding FSAs. For each triplet of data model, weighted-set and FSA, a new state object is created. In addition, a state-transition function is created which may be employed by all states which, given the exact data model and FSA state as input, triggers a state transition to the new corresponding state. In addition to a state transition, each transition function also invokes the logic of the state, which should output some value. A specific function, denoted herein as a “FSM Collapse Function” is used to transform the weighted-set into a simple logical behavior for the state. There are a number of distinct FSM Collapse Functions, each which can alter the exact behavior of the resulting FSM. Once each pair of values has been transformed into a state, a simple FSM representation of the Behavior AI has been created.

Given the description herein, it can be noted that, generally, any transformation process which may be applied to a Decision AI, may also be applied to a Behavior AI by treating the states of the Behavior AI as if it were an additional element (110) of the AI data model (100). As such, any transformation method may be applied to both a Decision AI, and a Behavior AI. Accordingly, hereafter transformations which may be carried out on both Decision AI and Behavior AI will refer to the subject of their transformation as Agent AI, and the descriptions will focus on the simpler form of a Decision AI, without loss to scope covering the Behavior AI.

In addition, an Agent AI may be transformed into an FSM by more involved processes. For example, a process which may perform analysis on the frequency of changes in element values to inform the exact manner of construction by blending logical tree and FSM structures, denoted herein as “State Delta-Frequency FSM Transformation”. First, an associative container is created, denoted as the “Delta Frequency Map”, with a key-value representing an element identifier, and a weighted-set as the associated data value. Then a list of pairs of data model (220) and associated weighted-set (230) are created from the Mappings (210) in the AI (200), and, if present, the AI cache (600), denoted as the “Mappings List”. For each element in each data model in the Mappings List, the element's value is added to the weighted-set in the Delta Frequency Map with the key equal to the element's identifier. Then, for each key in the Delta Frequency Map, the number of distinct values is counted. If the number for a given element is below an arbitrary given threshold value, that element is marked as a “state indicator” value. Once each of the element-keys has been iterated through, the number of distinct values in the associated weighted-set of elements marked as state indicators are multiplied to determine the number of state objects that will exist in the output FSM. Then a corresponding number of distinct state objects are created. For each state object, the remaining elements of the data model are then used to construct a Behavior Tree according to the general steps of the Behavior Tree transform described herein. The leaf nodes of the BT each corresponding to a specific data model indicated by the combination of the state and remaining non-state elements. Once each BT in each state object has been constructed, a non-trivial FSM representation of a given Agent AI has been created.

The exact details of the State Delta-Frequency FSM Transform may be altered in a number of ways depending on various factors. For example, one may choose to instead look at the statistical aspects of the unique element value weights, such as, but not limited to, standard deviation and average, to define the number and nature of states in a different manner. There also exist a variety of approaches which may be employed to generate specific forms of an FSM with internal BT structures which target efficient execution with regards to a variety of computational metrics, including, but not limited to, binary representation size, computational memory requirements, and computational time requirements. As such, anyone skilled in the Art will recognize that a variety of trivial modifications may be made to the algorithm described herein to produce a wide number of variations without loss of coverage within the Scope of the Invention.

### Agentic Artificial Intelligence Control System

Generally, an agentic artificial intelligence control system can provide a unified architecture that includes an agentic AI core, a training engine, a transformation engine, an execution runtime, a representation store, an interface layer, and a higher-order orchestrator arranged to exchange state, model parameters, and control directives. In one embodiment, the interface layer can ingest high-dimensional state-decision object pairs, the agentic AI core can encode the state in a data model and the decision object in a weighted-set within an AI associative container backed by an AI cache, and the training engine can update weights to learn state-decision mappings. In another embodiment, the transformation engine can generate behavior trees, decision trees, finite state machines, and/or hard-coded conditional logic and the representation store can persist these representations for deterministic execution by the execution runtime. Therefore, the agentic artificial intelligence control system can enable training from state-decision data, interpretable transformation with deterministic or stochastic node collapse, orchestration of multiple decision policies by the higher-order orchestrator, and deployment into legacy or resource-constrained targets, which addresses the stated challenges of unification, interpretability, and portable execution.

### Agentic AI Core

Generally, the agentic AI core implements a trainable mapping from input state objects to command outputs for behavioral control. More specifically, the agentic AI core can include an AI associative container that stores a plurality of weighted-set indexed by elements of a data model (e.g., feature objects with between 10 and 10\hat{ }6 dimensions), and can maintain an AI cache to accelerate selection over frequently accessed keys. Additionally, the agentic AI core can retrieve one or more weighted-set using a selection functions library that applies equality-, fuzzy-, and/or distance-based retrieval, and can resolve retrieved values using a collapse functions library that performs maximum-, minimum-, weighted-random-, and/or aggregate-sequence collapses. In particular, the agentic AI core enables transformation into interpretable trees, finite state machines, and/or conditional logic while preserving learned behavior, thereby addressing deployment in legacy environments, providing a unified reusable structure across domains, and supporting deterministic execution from high-dimensional state inputs.

### AI Associative Container

Generally, the AI associative container can maintain a mapping between a data model instance and a weighted-set using a keyed associative array or hash structure, enabling near-constant-time retrieval (e.g., amortized constant time under average load). More specifically, the AI associative container can store keys derived from a unique representation, unique identifier and/or a serialized representation of the data model and can store values that reference a weighted-set associated with decisions or actions for the corresponding data model instance. In one implementation, the AI associative container can receive inserts and updates from the training engine during observation of state-decision data and can serve lookups to the execution runtime for real-time selection using the selection functions library and/or collapse functions library. Additionally, the AI associative container can provide version tagging, concurrency control (e.g., sharded or lock-free buckets), optional integration with an AI cache for hot entries, and optional aggregation or merging of weighted-set to supply the transformation engine and repositories, thereby supporting scalable operation across high-dimensional state spaces and diverse deployment environments.

### AI Cache

Generally, the AI cache can include an array-based structure that stores recently accessed pairs of the data model and the weighted-set to accelerate retrieval during training and operation relative to the AI associative container. More specifically, the AI cache can apply temporal weighting during interaction with a training engine by increasing selection likelihood of recently observed state-decision mappings, and the AI cache can expose a capacity parameter (e.g., between 32 and 131072 entries) with LRU, FIFO, and/or domain-specific eviction strategies. Additionally, the AI cache can serve lookups in parallel with the AI associative container and can periodically synchronize or invalidate entries according to triggers from an execution runtime to maintain coherence across running representations. Alternatively, the AI cache can provide an auxiliary source to a transformation engine during construction of behavior trees, decision trees, and finite state machines to preserve transient associations, and the AI cache can be omitted for resource-constrained deployments or when a deterministic static configuration is required.

### Collapse Functions Library

Generally, the collapse functions library can provide a pluggable set of functions that accept a weighted-set and produce a single output value or subtree for attachment to a node of a behavior tree, a decision tree, and/or an FSM representation. More specifically, the collapse functions library can execute deterministic operations, such as max collapse, min collapse, max path collapse, min path collapse, sequence collapse, max FSM collapse and min FSM collapse using a configurable aggregation operation (e.g., addition, subtraction, multiplication, or division) with optional normalization across an exemplary range (e.g., 0.0-1.0). Additionally, the collapse functions library can execute stochastic operations, such as random collapse, weighted roll FSM collapse and random selector collapse, by sampling from a probability distribution proportional to element weights with optional seeding to ensure repeatable execution. In one implementation, the collapse functions library can expose an extensible interface to the transformation engine to select a collapse strategy per selector-populated partial representation, thereby reducing probabilistic or high-dimensional decision data into deterministic or stochastic logical nodes that operate in resource-constrained or legacy environments, which addresses the absence of standardized mechanisms for collapsing weighted structures during transformation and enables interpretable deployment.

### Training Engine

Generally, the training engine can process input state-decision pairs and generate structured training samples compatible with the agentic AI core. In one implementation, the training engine coordinates a training sample processor for sample construction, a function evaluation unit for fuzzy equality, strict equality, and distance computation, and a weight update module for parameter adjustment while optionally operating in batch and/or online modes, where batch processing aggregates updates over collections (e.g., between 2 and 1,000,000 samples) and online processing applies updates per sample to support real-time adaptation. More specifically, the training engine can update weights of a weighted-set and/or parameters of a data model within an AI associative container, and can tune selection parameters and collapse parameters according to outputs of the function evaluation unit. Furthermore, the training engine can accommodate high-dimensional state objects (e.g., dimensionality between 16 and 10,000) with domain-specific loss functions, update rules, and pre-processing pipelines, and can export learned parameters or structures for subsequent transformation by a transformation engine into behavior trees, decision trees, finite state machines, and/or hard-coded conditional logic.

### Transformation Engine

Generally, the transformation engine can receive a trained decision AI and/or behavior AI and generate target-specific logical structures, such as behavior trees, decision trees, finite state machines, and source-code level conditional logic suitable for legacy or resource-constrained environments. In one implementation, the transformation engine extracts a data model and a weighted-set from an agentic AI core, constructs a base target structure via a BT transformation module, a DT transformation module, and/or an FSM transformation module, populates selector and/or state nodes, and applies a collapse node function library and an FSM collapse function library to reduce probabilistic decisions via max-path, min-path, sequence, and/or weighted-random operations into deterministic or stochastic nodes. Additionally, the transformation engine can merge generated subtrees via a tree merging module and can serialize a unified logical representation via a hard-coded logic serializer and/or produce a data-driven artefact for interpretation by an execution runtime. Thus, the transformation engine provides a standardized, modular conversion pipeline that preserves learned behavior while enabling interpretable trees, FSMs, and code with collapsed decision logic, thereby addressing deployment into legacy targets, systematic interpretability, and efficient execution of high-dimensional control policies.

### Collapse Node Function Library

Generally, the collapse node function library can provide a collection of interchangeable collapse algorithms that transform a weighted-set into deterministic and/or stochastic nodes and sub-trees within a target representation, and the transformation engine can invoke these algorithms during the collapse weighted sets into deterministic or stochastic logic nodes step to generate behavior tree, decision tree, and finite state machine constructs. More specifically, the collapse node function library can implement Max Path Collapse and Min Path Collapse that select extremal values with configurable normalization and tie-break policies (e.g., epsilon smoothing between 1e-6 and 1e-2), Sequence Collapse that provides child nodes for respective values in the weighted-set and may aggregate outputs returned from the child nodes according to an operation selected from addition, subtraction, multiplication, and/or division with optional clamping (e.g., output range between −1e3 and 1e3), and Random Selector Collapse that samples according to relative weights with an optional temperature parameter (e.g., between 0.1 and 5.0) and a seeded pseudo-random generator. In one implementation, the collapse node function library can expose callable routines and/or modular plug-ins with a stable interface that accepts a mapping list context and a target type flag, and the collapse node function library can emit a collapsed partial representation configured for the tree merging module and the hard-coded logic serializer, with behavior selectable per decision tree transformation variant. Therefore, the collapse node function library enables systematic reduction of probabilistic weighted structures into interpretable logical nodes suitable for legacy and resource-constrained deployments while preserving learned behavior, which addresses the insufficiency of conventional mechanisms for collapsing weighted decisions into deterministic or stochastic logic nodes.

### FSM Collapse Function Library

Generally, the FSM collapse function library can provide a collection of interchangeable collapse algorithms that transform a weighted-set into deterministic and/or stochastic function within a target representation, and the transformation engine can invoke these algorithms during the collapse weighted sets into deterministic or stochastic logic functions step to generate finite state machine constructs. More specifically, the FSM collapse function library can implement Max FSM Collapse and Min FSM Collapse that select extremal values with configurable normalization and tie-break policies (e.g., epsilon smoothing between 1e-6 and 1e-2), and Weighted Roll FSM Collapse that samples according to relative weights with an optional temperature parameter (e.g., between 0.1 and 5.0) and a seeded pseudo-random generator. In one implementation, the FSM collapse function library can expose callable routines and/or modular plug-ins with a stable interface that accepts a mapping list context and a target type flag, and the FSM collapse function library can emit a partial representation configured for the hard-coded logic serializer, with behavior selectable per FSM or state delta-frequency FSM transformation variant. Therefore, the FSM collapse function library enables systematic reduction of probabilistic weighted structures into interpretable finite state automata suitable for legacy and resource-constrained deployments while preserving learned behavior, which addresses the insufficiency of conventional mechanisms for collapsing weighted decisions into deterministic or stochastic logical finite state mechanisms.

### Tree Merging Module

Generally, the tree merging module can merge a primary logical tree with one or more secondary logical trees to produce a unified logical representation by locating a root correspondence and recursively merging or attaching child subtrees according to node equivalence rules. More specifically, the tree merging module can determine equivalence using a mapping list, node identifiers and/or predicates, and can resolve conflicts via configurable policies such as union, override, or priority by weight, while preserving deterministic and/or stochastic semantics of selector, sequence, and random-selector nodes. In one implementation, the tree merging module can stream merged results into a running representation by emitting structural deltas to the representation store and/or the execution runtime, enabling idempotent updates through canonicalization, path hashing, and versioned merge checkpoints that interoperate with the collapse node function library. Thus, the tree merging module addresses deployment and interpretability challenges by producing an executable, merged tree suitable for legacy or resource-constrained systems without reauthoring behavior by hand.

### Execution Runtime

Generally, the execution runtime provides a deterministic execution environment for the agentic artificial intelligence control system and can execute native agentic AI representations and/or transformed control logic representation such as behavior trees, decision trees, finite state machines, or hard-coded conditional logic. More specifically, the execution runtime can retrieve a selected representation from the representation store, ingest input state objects via the interface layer, advance logical nodes or state transitions according to configured deterministic, stochastic, or hybrid modes, and emit output command objects to the actuator output interface. In one implementation, the execution runtime includes an interpreter and/or a bytecode generator and loader that respectively process tree or state structures at runtime or load compiled bytecode prior to deployment, with scheduling configured for fixed-tick or event-driven cycles over a target environment. Additionally, the execution runtime can manage memory and resource allocation for constrained targets, expose hooks to the higher-order orchestrator for multi-policy coordination, and provide lifecycle controls to start, pause, and resume execution of an execute function during operation.

### Representation Store

Generally, the representation store can persistently store behavior trees, decision trees, finite state machine graphs, and abstract syntax trees produced by the transformation engine and/or derived from the agentic AI core, and can organize stored items within a behavior tree repository, a decision tree repository, an FSM repository, and an AST repository. More specifically, the representation store can maintain versioned metadata with identifiers, timestamps, source-model lineage, and transformation parameters, enabling retrieval of historical versions, roll-back to prior states, and audit traceability verified via data-integrity codes (e.g., checksums and/or cryptographic hashes). In one embodiment, the representation store can expose an API configured to query, stream, and export representations in target-specific formats for embedded controllers, operating systems, software applications, video games, and electromechanical devices, and can enforce access-control policies that gate read/write/modify operations by role. Alternatively, the representation store can implement storage as a filesystem directory, a relational or document database, or a distributed object store, and can optionally synchronize with external version control systems and/or deployment pipelines to support continuous integration and delivery of serialized control logic artefact.

### Interface Layer

Generally, the interface layer mediates between an agentic artificial intelligence control system and a domain-specific environment by standardizing communication and/or data formats. More specifically, the interface layer can receive raw data via a sensor input interface and/or external APIs, transform the data via a state preprocessor into an input state object compatible with a data model of the agentic AI core, and forward the input to an execution runtime. Additionally, the interface layer can translate action selections into actuator commands via an actuator output interface and can adapt protocols and data schemas via a domain adapter to match a target environment. In one implementation, the interface layer exposes configuration parameters, supports bidirectional communication and error handling, and enables reuse of agentic AI logic across operating systems, software applications, video games, and electromechanical devices.

### Higher-Order Orchestrator

Generally, the higher-order orchestrator can coordinate a plurality of Decision AI instances using a finite-state-automaton-like control architecture that maintains a state indicator selecting an active Decision AI from a collection size (e.g., between 2 and 256). More specifically, the higher-order orchestrator can apply state transition functions that receive a high-dimensional input state and/or an output action of the active Decision AI to compute a next state, and the higher-order orchestrator can invoke interface functions tied to the current state for context-dependent logic under deterministic and/or stochastic policies. In one embodiment, the higher-order orchestrator can learn switching policies from state-decision data pairs and can expose an execution structure that the transformation engine converts into behavior trees, decision trees, finite state machines, and/or hard-coded conditional logic. Thus, the higher-order orchestrator enables hierarchical composition of multiple decision policies and provides a transformable, interpretable controller, addressing the difficulty of creating higher-order behavioral controllers and deploying learned control logic into legacy or resource-constrained environments.

### Method of Training, Operating, and Transforming an Agentic Artificial Intelligence Control System

Generally, the agentic artificial intelligence control system can execute a method that collects state-decision pairs via the training sample processor and the sensor input interface, records raw state snapshot and raw decision record, preprocesses data via the state preprocessor to yield a state-decision training dataset, and initializes an agentic data model in the agentic AI core. In one implementation, the training engine can train an Agent AI by applying weighted-set updates in the weight update module over the AI associative container and the selection functions library while the function evaluation unit evaluates performance over the state space, thereby producing a trained decision AI model aligned with the data model and optionally cached in the AI cache. Additionally, the execution runtime can execute the trained decision AI model via the interpreter and/or the bytecode generator within a runtime environment while the interface layer acquires sensor inputs and emits actuator outputs, and the higher-order orchestrator can combine multiple decision AIs into a behavior AI controller through the state transition manager and the execute function. Subsequently, the transformation engine can transform the trained decision AI model and/or the behavior AI controller by creating a mapping list, constructing a base target representation structure in the BT/DT/FSM transformation module, populating selector nodes or states from the data model, collapsing weighted-set into deterministic or stochastic logic nodes using the collapse node function library and the FSM collapse function library, merging structures in the tree merging module, serializing via the hard-coded logic serializer, and deploying a serialized control logic artefact to a target environment, where decision tree transformation variant, FSM transformation variants, and state delta-frequency FSM transformation variant configure construction and collapse strategies; therefore the method provides standardized conversion of learned behavior into interpretable logic for legacy or resource-constrained platforms, enables reuse across domains through a unified agentic structure, supports high-dimensional state handling for deterministic execution, and supplies deterministic and/or stochastic collapse mechanisms for decision trees and finite state machines.

Collect Training Data from State-Decision Pairs

Generally, the training sample processor can collect training data from state-decision pairs by ingesting a multi-dimensional state object from the sensor input interface and/or the domain adapter and pairing the state object with a decision generated by a human operator, a reference system, or the execution runtime. More specifically, the training sample processor can record state values to produce a raw state snapshot and can record a corresponding decision to produce a raw decision record from real-time telemetry, log extraction, and/or simulation traces. Additionally, the state preprocessor can preprocess and clean data by normalizing continuous features, quantizing and/or reducing dimensionality of high-cardinality variables, encoding categorical variables, and adding metadata such as timestamps, source identifiers, and quality metrics while optionally filtering, deduplicating, and aggregating samples. Thus, the training sample processor can assemble structured samples as a state-decision training dataset suitable for supervised learning and/or reinforcement learning within the training engine and for subsequent transformation into interpretable control logic.

### Record Corresponding Decision

Generally, the training sample processor records a decision executed by a reference agent in response to an observed state and generates a raw decision record. More specifically, the training sample processor can encode a structured object describing command identifiers, function targets, and parameter vectors, and can attach metadata such as timestamps, agent identifiers, and domain context. Additionally, the training sample processor can support single-agent and/or multi-agent configurations and can capture decision granularity ranging from high-level commands to low-level actuator signals and intermediate function calls. Then, the training sample processor can persist the raw decision record to a buffer and/or datastore and can link the raw decision record to a recorded raw state snapshot via a shared key for downstream preprocessing into a state-decision training dataset.

### Record State Values

Generally, the sensor input interface can record state values by acquiring current values for each element defined in the data model from hardware sensors, software memory probes, and/or application programming interface hooks of a deployment environment. In one implementation, the interface layer can sample according to a scheduling policy (e.g., periodic sampling between 1 and 1000 Hz, event-triggered acquisition, and/or continuous streaming) and timestamp each capture, generating a raw state snapshot that maps each data model element to a corresponding value. Additionally, the sensor input interface and the state preprocessor can apply lightweight encoding, normalization, and/or quantization to yield an interim representation compatible with downstream processing while preserving the raw state snapshot for lossless reference. Alternatively, the agentic AI core can supplement unavailable elements by querying the AI cache or computing derived features via the selection functions library, and the training sample processor can persist the raw state snapshot for association with a corresponding raw decision record.

### Preprocess and Clean Data

Generally, the state preprocessor can receive the raw state snapshot and the raw decision record and generate a cleaned state-decision training dataset by executing configurable routines. More specifically, the state preprocessor can detect and filter outliers according to statistical bounds (e.g., z-score thresholds between 2 and 5), impute missing values via mean/median/mode or model-based estimation, and discretize continuous features into bins (e.g., between 5 and 256 bins) and/or normalize feature scales (e.g., to [0,1] or [−1,1]). Additionally, the state preprocessor can encode categorical variables, apply domain-specific cleaning rules provided by the domain adapter, and apply routines globally and/or selectively per feature with parameters supplied automatically and/or by a user. Thus, the state preprocessor can produce bounded and comparable samples that support deterministic and reproducible construction of the data model and the weighted-set for downstream training, inference, and transformation, and in some variants the state preprocessor can bypass processing when inputs are already structured and anomaly-free.

### Initialize Agentic Data Model

Generally, the agentic AI core can initialize the data model by defining a set of element identifiers that specify each dimension of a state space and by configuring data types and default values for each element. In one implementation, the agentic AI core can allocate an AI associative container, such as a hash map or a tree map, that maps a normalized tuple of element values to a weighted-set of observed decision outputs while supporting efficient lookup and insertion. More specifically, the agentic AI core can register similarity functions for tuple comparison (e.g., strict equality, fuzzy equality, or distance metrics) and can bind selection functions from a selection functions library and collapse functions from a collapse functions library to govern inference and downstream transformation behavior. Additionally, the agentic AI core can allocate memory and seed initialization routines for the associative container and the weighted-set entries, thereby producing an initialized agentic data model that provides a structured and deterministic mapping from high-dimensional states to decisions while supporting probabilistic and/or deterministic policy execution.

### Train Agent AI Using Weighted Set Updates

Generally, the training engine updates a weighted-set representation by processing each sample of the state-decision training dataset according to an initialized agentic data model. More specifically, the weight update module accesses an AI associative container (e.g., a hash map or dictionary) to locate or create a key defined by the data model, evaluates a reward or confidence value via the function evaluation unit, and then updates the weighted-set of the key using an additive and/or multiplicative rule with optional learning-rate scaling (e.g., between 1e-4 and 1.0) and optional weight decay (e.g., a factor between 0.90 and 0.999). In one implementation, the training sample processor provides samples in single-item and/or mini-batch form, the selection functions library constrains the candidate decision set per key, and the weight update module applies normalization and/or regularization to maintain a stable distribution across decisions. Then, the training engine persists updated weighted-set into the agentic AI core to yield a trained decision AI model configured for inference and for downstream transformation into behavior trees, decision trees, and/or finite state machines.

### Execute Agent AI During Operation

Generally, the execution runtime can execute the trained decision AI model by receiving a live state object from the interface layer and generating a decision for the runtime environment. More specifically, the execution runtime can apply one or more selection functions from the selection functions library to the data model to locate a nearest-matching key for the state object and retrieve a corresponding weighted-set from the agentic AI core. Additionally, the execution runtime can invoke a collapse function from the collapse functions library to resolve the weighted-set according to a strategy (e.g., maximum-weight, minimum-weight, weighted-random, or aggregate), producing a command object and/or a function call. Then, the actuator output interface can emit the command to a host system for single-step execution and/or hierarchical multi-step sequencing under coordination of the higher-order orchestrator, thereby supporting deterministic and/or stochastic real-time operation in resource-constrained domains.

### Orchestrate Multiple Agent AIs in Behavior AI

Generally, the higher-order orchestrator can instantiate a decision AI collection within a behavior AI controller and maintain a reference pointer to a selected trained decision AI model as a current module. In one implementation, the execute function can receive an input state from the interface layer, route the input state to the current trained decision AI model, and relay a decision object produced by the current trained decision AI model as an output through the actuator output interface. Additionally, the state transition manager can update the reference pointer according to a transition function defined by conditional logic and/or learned policies, thereby selecting a next trained decision AI model in a manner analogous to a finite state automaton; the transition function can evaluate state features, returned decision fields, and/or timing conditions. Therefore, the higher-order orchestrator can enable modular, context-dependent control across arbitrary numbers of trained decision AI model while preserving deterministic execution when configured with explicit transitions, which addresses the challenge of building higher-order controllers and supports deployment into legacy finite state machine and behavior tree environments.

Transform Trained Agent AI into Alternative Representations

Generally, the transformation engine can transform a trained decision AI model and/or a behavior AI controller into alternative control representations by iterating a mapping between data model elements and weighted-set entries maintained in the AI associative container and optionally cached in the AI cache. More specifically, the BT transformation module, the DT transformation module, and the FSM transformation module can construct a base selector hierarchy from a mapping list, populate selector nodes or FSM states according to the data model, and the collapse node function library and/or the FSM collapse function library can collapse weighted-set via a selected operation (e.g., max, min, sequence aggregation, or probability-weighted random) to produce deterministic or stochastic logic nodes. Then, the tree merging module can merge partial structures into a unified logical representation, and the hard-coded logic serializer and/or the execution runtime can serialize or export a behavior tree, a decision tree, an FSM, and/or hard-coded conditional logic for deployment. Thus, the transformation engine addresses deployment and interpretability challenges by providing a standardized, parameterized conversion path that preserves learned behavior while generating deterministic or stochastic structures suitable for legacy or resource-constrained environments.

Create Mapping List from Data Models and Weighted Sets

Generally, the transformation engine can create a mapping list by enumerating pairs formed from a data model and a weighted-set contained in an AI associative container and/or an AI cache. More specifically, the transformation engine can traverse each data model in the AI associative container, locate a corresponding weighted-set via indexed iteration and/or key-based lookup, and append each identified pair to an ordered collection with a deterministic order (e.g., stable insertion order or identifier-sorted order). In one implementation, the transformation engine can further traverse an AI cache array to append additional data model and weighted-set pairs derived from a trained decision AI model and/or a behavior AI controller. Then, the transformation engine can persist the mapping list as an array and/or list for use by subsequent steps to construct a base target representation structure and to populate selector nodes or states according to the data model.

### Construct Base Structure for Target Representation

Generally, the BT transformation module can, for each entry of the mapping list, allocate an initial empty artefact parameterized by a target type to produce a base target representation structure. In one implementation, the BT transformation module can instantiate a tree root node (e.g., a placeholder leaf and/or a generic selector) to anchor subsequent node insertion for behavior tree and/or decision tree targets. Alternatively, the FSM transformation module can instantiate a blank state object with an uninitialized state indicator and default transition function containers to serve as an initial state for an FSM, including variants influenced by a state delta-frequency FSM transformation variant. Further, the transformation engine can allocate the artefact as an object in memory with fields initialized to default or null values and register the artefact for subsequent population and merging within the transformation pipeline to provide a deterministic anchor.

### Populate Selector Nodes or States According to Data Model

Generally, the transformation engine can populate selector nodes or finite-state transitions according to a data model by receiving a base target representation structure and producing a selector-populated partial representation. More specifically, the transformation engine can iterate over each element of the data model and instantiate a selector node in a behavior tree and/or decision tree, or define a state transition function in a finite state machine, where each selector or transition routes execution according to element values using deterministic and/or stochastic policies parameterized by element type and routing logic. In one implementation, the transformation engine can traverse elements recursively or sequentially according to a mapping list to form hierarchical paths that terminate in placeholder leaf nodes for trees or terminal states for finite state machines, which provide insertion points for subsequent collapse of weighted-set and action logic. Thus, the transformation engine can convert high-dimensional state representations into interpretable control structures suitable for legacy or resource-constrained runtimes, addressing deployment and interpretability challenges.

Collapse Weighted Sets into Deterministic or Stochastic Logic Nodes

Generally, the transformation engine can apply the collapse node function library to a selector-populated partial representation to convert each weighted-set into an executable node and produce a collapsed partial representation. More specifically, the collapse node function library can normalize weights (e.g., L1 or SoftMax over a tolerance range of 1e-9 to 1e-3), select a collapse algorithm, and emit a node compatible with a behavior tree, a decision tree, and/or a finite state machine. In one implementation, the collapse node function library can perform a Max Path Collapse or Min Path Collapse to generate a deterministic node that selects a branch index or an action identifier with a repeatable tie-break rule (e.g., stable index order). In another implementation, the collapse node function library can perform a Sequence Collapse that instantiates child nodes to process respective values of the weighted-set and may aggregate the values returned from the child nodes by an operator family (e.g., addition, subtraction, multiplication, division) with parameterized precision (e.g., 8-64 bits) and clamping ranges derived from the data model. Additionally or alternatively, the collapse node function library can generate a stochastic node using a Random Selector Collapse with weight-proportional sampling, where a pseudo-random generator of the execution runtime can use a seed policy (e.g., per-episode or per-timestep) to ensure reproducible or varying behavior. In particular, the FSM collapse function library can specialize node emission for state transitions by mapping a collapsed outcome to a next-state identifier and a transition guard constructed from the state preprocessor outputs and optional thresholds (e.g., hysteresis in a range of 1-10% of signal scale). Thus, the collapse step converts probabilistic structures into deterministic or stochastic logic nodes that execute efficiently in legacy or resource-constrained systems, addressing the lack of mechanisms to collapse weighted decision structures while preserving interpretable behavior.

Merge Generated Structures into Running Representation

Generally, the transformation engine can employ the tree merging module to merge a collapsed partial representation and/or multiple generated partial structures into a running representation to yield a unified logical representation suitable for the execution runtime and for storage in the representation store. More specifically, in the merge generated structures into running representation step, the tree merging module can identify a root node of each partial behavior tree, decision tree, abstract syntax tree, and/or finite state machine, locate a corresponding node in the running representation via hash-based node matching (e.g., 64-256-bit hashes), structural isomorphism checks, and recursive descent, and treat finite state machine states and transitions as nodes and labeled edges for equivalence evaluation. In one implementation, the tree merging module can attach non-matching child nodes with descendant subgraphs recursively, merge matching subtrees to unify duplicate paths, remove redundant nodes, normalize transition labels and guard conditions, and update a mapping list and references of a base target representation structure and/or selector-populated partial representation stored in the representation store while preserving deterministic and/or stochastic execution semantics referenced by the higher-order orchestrator. Therefore, the transformation engine can produce a single rooted, fully connected representation that preserves learned behavior while enabling interpretable, deterministic execution in resource-constrained or legacy environments, which addresses deployment and maintainability challenges of heterogeneous control logic formats.

### Serialize or Export Representation for Deployment

Generally, the transformation engine can perform the step of serialize or export representation for deployment by traversing the unified logical representation and emitting a serialized control logic artefact that preserves node sequencing, guard conditions, and action bindings. More specifically, the transformation engine can select a reversible data-driven format (e.g., JSON or XML trees encoding nodes, edges, and parameters) and/or direct a hard-coded source code emission, while the hard-coded logic serializer can generate conditional constructs, switch-case blocks, and function invocations in a target language. In one implementation, the transformation engine can annotate emitted elements with runtime metadata for the interpreter and/or bytecode generator to enable deterministic or stochastic execution semantics within the runtime environment under memory and latency constraints. Thus, the serialization step produces a representation that the target platform can compile and/or interpret, which addresses deployment of learned behavior into legacy and resource-constrained systems without redesigning the control logic.

### Deploy Transformed Representation to Target Environment

Generally, the runtime environment can deploy the transformed control logic representation to a host system by loading a serialized control logic artefact and initializing a target environment loaded with transformed logic configuration. More specifically, the runtime environment can invoke the interpreter and/or the bytecode generator to load source code, bytecode, configuration files, and/or object graphs into host memory and/or storage and to bind callable entry points for execution. Additionally, the interface layer can map host state to the input schema of the transformed control logic representation via the domain adapter and the sensor input interface, and can map produced actions to host actuation via the actuator output interface. In one implementation, the runtime environment enables deterministic and/or stochastic execution of the transformed control logic representation within the host, thereby preserving behavior learned by the agentic artificial intelligence control system during operation.

I claim:

1. An agentic artificial intelligence control system, comprising:
an agentic AI core that includes:
a data model defining a plurality of element identifiers for high-dimensional state objects;
an AI associative container mapping each data model instance to a corresponding weighted-set of command values with associated weights;
a selection functions library configured to retrieve one or more weighted-set for a received state object using at least strict-equality, fuzzy-equality, or distance-based matching;
a collapse functions library configured to resolve a retrieved weighted-set into a command output via at least one collapse function selected from Max Collapse, Min Collapse, Sequence Collapse, or Random Collapse;
a transformation engine operatively coupled to the agentic AI core and configured to convert a trained Agentic AI into at least one alternative control-logic representation chosen from a Behavior Tree, Decision Tree, Finite State Machine, or hard-coded conditional logic;
the transformation engine further including a tree merging module operative to merge partial logical structures into a unified logical representation;
an execution runtime configured to execute both (i) a native weighted-set representation and (ii) an alternative control-logic representation output by the transformation engine;
an interface layer comprising:
a sensor input interface that normalizes raw sensor or application data into the data model format; and
an actuator output interface that converts command outputs from the execution runtime into domain-specific actions.

2. The system of claim 1, further comprising a training engine comprising:
a training sample processor;
a weight update module; and
a function evaluation unit configured to select, based on predictive performance metrics, a Selection Function and a Collapse Function for subsequent use.

3. The system of claim 1, wherein the transformation engine comprises a BT transformation module configured to generate a selector hierarchy for each element of the data model and to attach a collapse-node sub-tree at terminal leaves.

4. The system of claim 1, wherein the transformation engine further comprises a DT transformation module configured to emit value-based branching logic and to store a resulting Decision Tree in a Decision Tree Repository.

5. The system of claim 1, wherein the transformation engine further comprises an FSM transformation module that employs a FSM transformation variant or state delta-frequency FSM transformation variant to establish state indicators based on low-variance elements of the data model.

6. The system of claim 1, wherein the transformation engine includes a hard-coded logic serializer configured to convert a generated logical tree into source-code level conditional statements in a target programming language.

7. The system of claim 1, further comprising a representation store having a behavior tree repository, a decision tree repository, an FSM repository, and an AST repository for persistent, versioned storage of generated control-logic artefacts.

8. A method of training, operating, and transforming an agentic artificial intelligence control system, the method comprising:
collecting training data by recording raw state snapshot and corresponding decisions to form state-decision pairs;
preprocessing and cleaning the collected data to generate a State-Decision Training Dataset;
initializing an Agentic data model that maps state element identifiers to an associative container pre-configured with selection and collapse functions;
training an Agent AI by updating weights in weighted-set within the associative container in response to each sample from the State-Decision Training Dataset;
executing the trained Agent AI during operation by retrieving a weighted-set for a live state object and collapsing the weighted-set to output a command object;
transforming the trained Agent AI into an alternative control-logic representation by:
creating a mapping list of all data model and weighted-set pairs;
constructing a base structure for a target representation;
populating selector nodes or state transitions according to the data model;
collapsing weighted-set into deterministic or stochastic logic nodes;
merging generated structures into a unified logical representation; and
serializing or exporting the representation for deployment;
deploying the serialized representation to a target environment incapable of natively executing the weighted-set form.

9. The method of claim 8, wherein the step of collapsing weighted-set into deterministic or stochastic logic nodes employs a Random Selector Collapse to maintain stochastic behavior in the exported representation.

10. The method of claim 8, wherein transforming the trained Agent AI includes selecting a decision tree transformation variant and pruning unreachable branches to reduce representation size.

11. The method of claim 8, further comprising, prior to deploying, storing the serialized representation in a representation store that maintains version-control metadata.

12. The method of claim 8, wherein deploying the serialized representation includes loading the serialized representation into a runtime environment on a resource-constrained embedded device.

13. The method of claim 8, further comprising orchestrating a plurality of Decision AI modules within a behavior AI controller that updates a current-reference pointer based on command outputs.

14. The method of claim 8, wherein training the Agent AI includes using a function evaluation unit to benchmark multiple Selection Functions and to select a Selection Function having highest predictive accuracy.

15. A transformation engine for converting a trained Agentic AI into alternative control-logic representations, comprising:
a BT transformation module configured to generate Behavior Trees with selector hierarchies and collapse-node leaves;
a DT transformation module configured to generate Decision Trees with value-based branching;
an FSM transformation module that incorporates a FSM transformation variant and state delta-frequency FSM transformation variant to define Finite State Machine states from low-variance data elements;
a collapse node function library providing Max Path Collapse, Min Path Collapse, Sequence Collapse, and Random Selector Collapse;
a FSM collapse node function library providing Max FSM Collapse, Min FSM Collapse and Weighted Roll FSM Collapse;
a tree merging module operative to integrate partial logical structures into a unified logical representation having a single root node;
a hard-coded logic serializer configured to output source-code level conditional logic corresponding to the unified logical representation; and
a representation store communicatively coupled to the modules for persistent storage of generated Behavior Trees, Decision Trees, FSMs, and ASTs.

16. The transformation engine of claim 15, wherein the BT transformation module is configured to merge selector hierarchies derived from both an AI associative container and an AI cache to preserve transient state-action associations.

17. The transformation engine of claim 15, wherein the FSM transformation module is configured to select state indicators by comparing a number of distinct values for each element of a data model against a configurable threshold.

18. The transformation engine of claim 15, wherein the hard-coded logic serializer outputs C-language source code comprising nested if-else constructs matching a logical tree structure.

19. The transformation engine of claim 15, further comprising an interface to a bytecode generator configured to convert an abstract syntax tree form of the unified logical representation into target-specific bytecode executable by a virtual machine.
